(19) United States
(12) Patent Application Publication
(10) Pub. No.: US 2023/0296520 A1
(43) Pub. Date: Sep. 21, 2023

(54) METHOD AND DEVICE FOR CAPTURING NANOSCOPIC IMAGES OF SAMPLES DYED WITH MULTIPLE DYES

(71) Applicant: ABBERIOR INSTRUMENTS GMBH, Gottingen (DE)

(72) Inventors: Benjamin HARKE, Gottingen (DE); Roman SCHMIDT, Gottingen (DE); Winfried WILLEMER, Bovenden (DE)

(21) Appl. No.: 18/200,957

(22) Filed: May 23, 2023

Related U.S. Application Data
(63) Continuation-in-part of application No. PCT/EP2021/082460, filed on Nov. 22, 2021.

(30) Foreign Application Priority Data
Nov. 24, 2020 (DE) 10 2020 131 047.1

(51) Int. Cl. G01N 21/64

(52) U.S. Cl. CPC G01N 21/6458

(57) ABSTRACT

The present disclosure relates to localisation microscopic investigations of samples stained with multiple dyes. According to the present disclosure, it is either provided that a singulated excitable fluorophore of a first species is excited with excitation light of two different wavelengths and that a localisation of the fluorophore is obtained for each of the two wavelengths, or that first test excitation is performed in order to then select a wavelength for excitation light with which a singulated fluorophore is localised. In the first case, the difference in the localisations of the one or preferably multiple individual fluorophores obtained in this way is determined and used to obtain localisations of fluorophores of a different species and those of the first species in a common spatial reference system. The second case is advantageously applicable for tracking structures. Also in the second case, the advantages of the first case can be additionally realised.

### CROSS-REFERENCE TO RELATED APPLICATIONS

The present application is a continuation-in-part application and claims priority to and the benefit of International Patent Application No. PCT/EP2021/082460, filed on Nov. 22, 2021, the entire contents of which is incorporated herein by reference.

### TECHNICAL FIELD OF THE PRESENT DISCLOSURE

The present disclosure relates to localisation microscopy, in particular MINFLUX microscopy. The present disclosure enables improved nanoscopic imaging of multiply-stained samples, i.e. samples stained with multiple different fluorescence markers, and tracking of single molecules, i.e. fluorophores, in multiply stained samples.

### PRIOR ART

Localisation microscopy allows imaging of samples with a resolution below the Abbe diffraction limit. To image a sample, it is stained with markers that behave in such a way that they are fluorescent for at least one period of time, i.e. they are in a state where they can be excited to fluoresce, and are not fluorescent most of the time. It is commonly referred to as the markers are blinking. This may be due, for example, to the fact that the total amount of markers is in an equilibrium state in which a small proportion of the markers are fluorescent and a large proportion are not. The sample is prepared or treated in such a way that, on average, some or even many markers are fluorescent over the sample, but the fluorescent markers typically have distances between them that are approximately equal to or greater than, for example, the diameter of a diffraction-limited excitation light spot. If the sample is now exposed to excitation light, the light from the individual fluorescence-capable fluorophores can be detected with such spatial resolution that an image is obtained for each individual fluorophore whose position can be determined with an uncertainty that is much smaller than the Abbe diffraction limit. Alternatively, the sample can also be exposed to excitation light, for example with a sequence of structured excitation light distributions, in such a way that the positions of the fluorescent markers can be determined from the detected fluorescence light on the basis of the knowledge about the excitation with an uncertainty that is much smaller than the Abbe diffraction limit. The positions of a large number of markers are now determined in temporal sequence, whereby a plurality of markers are already detected simultaneously when using localisation microscopy in the wide-field or with parallelised localisation microscopic methods. Finally, an image of the sample is obtained from the set of positions determined in this way.

If an image of a sample stained with different species of markers, for example to mark different structures, is to be obtained by means of a localisation microscopy procedure, various problems arise. Even if each species of the chosen markers is suitable for localisation microscopy on its own, this is often not true for the pair of species or the entire set of markers. This is because if the conditions are set such that one species of markers has a suitable equilibrium state, then under the same conditions this species or another species of markers may be either too rarely fluorescent or not fluorescent at all, or too frequently fluorescent. Furthermore, the imaging conditions for different colors, i.e. wavelengths, are always slightly different, so that uncertainty arises with regard to the co-localisation of markers of different species.

When the term co-localisation is used in publications referring to data of non-super-resolution microscopy techniques such as simple fluorescence microscopy or light sheet fluorescence microscopy, it is regularly understood to mean, that signals of co-localised fluorophores cannot be separated locally in the image, i.e. that they appear within the same image pixel (see for example in “New Methods to Evaluate Colocalization of Fluorophores in Immunocytochemical Preparations as Exemplified by a Study on A_{2A} and D₂ Receptors in Chinese Hamster Ovary Cells”, Luigi F. Agnati et al, J Histochem Cytochem 53:941-953, 2005). With regard to localisation microscopy procedures, this term is understood more generally, namely in the sense that co-localisation of different species of fluorophores is understood to mean the determination of the spatial relationship in which the different species of fluorophores are arranged. This also includes the determination that the locations of different species of fluorophores are spatially inseparable in the image.

In the article “A guided tour into subcellular colocalization analysis in light microscopy”, S. Bolte and F. P. Cordelieres, Journal of Microscopy, Vol. 224, Pt 3, pp. 213-232, (2006), which is referred to as “Tutorial Review”, it is pointed out that it is essential to avoid that fluorescent light of one fluorophore species generates a signal in a detection channel assigned to another fluorophore species, i.e. a bleed-through between detection channels should be avoided; furthermore, it is to be avoided that excitation light, which is intended to excite one fluorophore species, also excites another fluorophore species, i.e. cross-excitation or cross-talk of the fluorescence excitation is to be avoided. Furthermore, it is recommended that the images of different fluorophore species are not taken simultaneously, but sequentially. Both bleed-through between detection channels and cross-excitation lead to a mixing of spectral channels. If this occurs as a disadvantageous disturbance, procedures for spectral unmixing could be applied. In principle, however, mixing of the spectral channels is considered a disturbance.

In the publication “Ultrahigh-Resolution Colocalization of Spectrally Separable Point-like Fluorescent Probes”, Xavier Michalet et al., METHODS 25, 87-102 (2001), https://doi.org/10.1006/meth.2001.1218, a method for co-localisation of different quasi-point-like fluorescent emitters is demonstrated. The emitters are excited in a confocal, scanning arrangement with one and the same excitation light source or excitation wavelength. In one of the arrangements used, the detection path is divided into two spectral channels by means of a spectral beam splitter, with detection in each of the channels being performed with a photon-counting detector; in another arrangement, detection is spectrally resolved using a prism and a camera. As long as it is ensured that only a single point emitter is located within the resolution width for each spectral channel, the locations of the individual emitters can be determined for each spectral channel from point spread functions, which have been recorded by scanning, with an accuracy far better than the resolution limit. Thus, distances of different emitters can also be determined with very high resolution, which ultimately depends in particular on the amount of detected photons, i.e. fluorescence emitters that can be separated in the detection light but can be excited with the same excitation wavelength can be co-localised with super-resolution. As an advantage of using only one excitation wavelength, the authors point out that chromatic errors in the excitation path are completely eliminated.

From the publication by Leila Nahidiazar et. al, “The molecular architecture of hemidesmosomes, as revealed with super-resolution microscopy”, Journal of Cell Science 128, p. 3714-3719 (2015); https://doi.org/10.1242/jcs.171892, in conjunction with the associated “Supplementary information”, procedures for localisation microscopy in two as well as three colors using a wide-field fluorescence microscope are known. A sample is stained with the dyes Alexa Fluor 647, Alexa Fluor 488 and, if applicable, Alexa Fluor 532. A special buffer solution, which the authors call OXEA, is used that allows all three dyes to be used for localisation microscopic imaging, specifically for a technique known as ground-state depletion followed by individual molecule return (GSDIM) microscopy. For imaging in two colors, first imaging is done using the dye Alexa Fluor 647, which is excited by a laser with light of a wavelength of 647 nm. This is followed by imaging using the dye Alexa Fluor 488, which is excited by a laser with light of a wavelength of 488 nm. According to the authors, both dyes can be imaged independently and without mutual interference. For imaging in three colors, additionally the dye Alexa Fluor 532 is used. First, the above steps are carried out, whereby a band-pass filter is used in the detection path when using Alexa Fluor 488 in order not to co-detect fluorescent light emitted by the third dye Alexa Fluor 532. Finally, imaging is performed using the Alexa Fluor 532 dye excited by a laser with light of a wavelength of 532 nm. The use of this third dye takes advantage of the fact that the dye Alexa Fluor 488 was bleached to such an extent in the previous steps that it emits sufficiently little interfering fluorescence. The image data obtained in this way are post-processed individually, then corrected for any drift that occurs, and finally images are generated that are corrected for any chromatic aberrations that occur. In order to determine the distances of the structures observed in different colors, the images are evaluated using the knowledge of the shape of imaged structures. In this way, the distances of marked structures are determined with less uncertainty than the uncertainty resulting from the uncertainties of the individual localisations of two different fluorophores. From the later publication by Leila Nahidiazar et. al, “Optimizing Imaging Conditions for Demanding Multi-Color Super Resolution”, PLoS ONE 11 (7): e0158884. (2016), https://doi.org/10.1371/journal.pone.0158884, it is known that the above correction for drift relies either on cross-correlation techniques or on the imaging of special reference markers integrated into the samples, namely fluorescent beads.

From the publication “Dual-color superresolution imaging of genetically expressed probes within individual adhesion complexes”, Hari Shroff et. al., Proceedings of the National Academy of Sciences, 104 (51) 20308-20313; (2007), https://doi.org/10.1073/pnas.0710517105, another method for localisation microscopy in two colors using a wide-field fluorescence microscope is known. Two different photoactivatable dyes are used, both of which can be activated with light of a wavelength of 405 nm, but are excited with different wavelengths and bleached if necessary. In a first sequence of steps, activation light and longer wavelength excitation light are applied and the fluorescent molecules are localised; this is done until a large number of fluorophores are localised. Thereby the excited dye bleaches out. Then, first those shorter wavelength fluorophores that are then in an excitable state are deactivated with an intense light pulse at 488 nm, which is the shorter excitation wavelength, so that subsequently all shorter wavelength fluorophores are in a non-excitable state. Afterwards, as for the first fluorophore species, a localisation of the fluorophores excitable with the shorter wavelength takes place. It is emphasised that the fluorophores show very little blead-through, i.e. the images in the different channels have little influence on each other.

From the publication “A user-friendly two-color super-resolution localisation microscope”, Teng Zhao et. al., Opt. Express 23, 1879-1887 (2015), a method of localisation microscopy on two-color stained samples is known. A sample is stained with two dyes, Alexa Fluor 647 and Alexa Fluor 750. A special buffer solution is used, which is adjusted in such a way that both dyes behave as equally as possible with regard to the switching properties important for localisation microscopy. The sample is simultaneously exposed to fluorescence excitation light for both dyes in the TIRF wide-field mode (TIRF: total internal reflection microscopy). In the detection path, the fluorescence of one dye is separated from that of the other. The fluorescence signals are detected in different halves of the same camera sensor. To avoid color-dependent deviations of the determined locations of different fluorophores, a calibration is performed. For the calibration, aggregates are created that contain fluorophores of both species and have a total size below the Abbe diffraction limit. A number of such aggregates are placed on a coverslip, the coverslip with the aggregates is observed under the microscope, and the aggregates are localised. Since the aggregates contain fluorophores of both species, fluorescent light is detected for each aggregate in both sensor halves. Based on this measurement, the detector halves are mapped to each other. The microscope calibrated in this way can be used for several weeks to take pictures that are free of chromatic errors.

In the publication “Multicolor Super-resolution Imaging with Photo-switchable Fluorescent Probes”, W Mark Bates et. al, Science; 317(5845):1749 pp, (2007), https://doi.org/10.1126/science.1146598, another method for wide-field localisation microscopy on multiply-stained samples is presented. Instead of simple fluorophores, dye pairs are used in each case. One partner of the dye pair, called activator, acts as a substance that determines the activation wavelength of the dye pair, the other partner, called reporter, is a substance that determines the excitation wavelength and the emission wavelength of the dye pair. The use of different activator-reporter pairs enables selective activation and thus sequential localisation of the different pairs, or simultaneous activation and simultaneous localisation in different detection channels, namely when the emission wavelengths of the reporters differ. The sequential method based on activator-reporter pairs with different activation wavelengths is demonstrated, i.e. proven by experimentally obtained images. Cross-talk between color channels is addressed. In this respect, it is stated that it is low for the activator-reporter pairs used.

In the publication “Multicolor Fluorescence Nanoscopy in Fixed and Living Cells by Exciting Conventional Fluorophores with a Single Wavelength”, Ilaria Testa et. al, Biophysical Journal, Volume 99, 2686-2694, (2010), https://doi.org/10.1016/j.bpj.2010.08.012, another GSDIM method for wide-field localisation microscopy in multiple colors is presented. One and the same laser, specifically a continuous wave laser of a wavelength of 488 nm, is used for the excitation of all dyes as well as for the depopulation of the ground state of all dyes. The fluorescence signal of all fluorophores is splitted into two color channels in the detection path and detected respectively within two sub-areas of one and the same camera sensor, so that fluorescence light with a wavelength above a cut-off wavelength is essentially detected on one part of the sensor and with a wavelength below a cut-off wavelength on the other. In this way, a pair of point images is obtained for each emitter in the sample. The ratio of the fluorescence quantity signals of each individual fluorophore in the two sensor halves is used to determine which fluorophore has caused a specific point image pair. Subsequently, each dot image can be assigned not only a location value but also color information. The procedure is based on the fact that it is ensured or known that each individual spot is caused by one molecule, i.e. that there is no signal that could have arisen as a mixture of different fluorescence emissions.

In the publication “Multicolor Far-Field Fluorescence Nanoscopy through Isolated Detection of Distinct Molecular Species”, Mariano Bossi et. al, Nano Lett, 8, 8, 2463-2468, (2008), https://doi.org/10.1021/n1801471d, another method for wide-field localisation microscopy in multiple colors is presented. Different fluorescent dyes are used, all of which can be switched from a non-fluorescent state to a fluorescent state by activation light with a wavelength of 375 nm and, all of which also can be excited to fluorescence by means of excitation light of one and the same wavelength of 532 nm. The fluorophores have very different emission spectra. The resulting fluorescence is detected spatially resolved in two channels with different spectral sensitivity, the species of emitter is deduced from the ratio of the fluorescence quantities detected for each individual emitter, and localisation is performed on the basis of the local distribution of the fluorescence. In the associated “Supplementary information”, it is explicitly mentioned that the spatial coordinates of the two spectral channels are assigned to each other by means of the imaging of fluorescent beads that emit in both spectral channels.

In the publication “Evaluation of fluorophores for optimal performance in localisation-based super-resolution imaging”, Graham T Dempsey et al, Nat Methods 8, 1027-1036 (2011), https://doi.org/10.1038/nmeth.1768, a method for imaging using STORM on samples stained with four different fluorescent dyes is described. Four dyes are specifically selected that differ greatly in both their excitation spectra and their emission spectra. These are each excited individually with an associated laser and the associated fluorescence is detected in an associated spectral channel. The choice of dyes and excitation wavelengths ensures that no cross-excitation occurs, so that the individual images are only minimally disturbed by fluorescence from the other dyes. The color channels of the imaging system are registered to each other by imaging gold beads under wide-field illumination in all detection channels before each individual image acquisition on the sample. The authors state that the uncertainty of the co-registration is less than 20 nm. Drifts that occur over time during imaging are corrected using image correlation techniques.

In the publication “Nanoscale subcellular architecture revealed by multicolor three-dimensional salvaged fluorescence imaging”, Yongdeng Zhang et al., Nat Methods 17, 225-231 (2020), https://doi.org/10.1038/s41592-019-0676-4, a method for localising fluorophores in a sample stained with multiple fluorescent dyes is presented, which is performed on a microscope with a 4-Pi detection setup. Excitation light is directed via a dichroic element through an objective onto the sample. Fluorescent light emitted by fluorophores in the sample is, on the one hand, guided via the same objective onto a first spatially resolving detector, whereby only the part of the fluorescent light with longer wavelengths than the excitation light passes the dichroic element and reaches the first detector; on the other hand, fluorescent light is guided in the opposite direction through a further dichroic element corresponding to the first one via a mirror onto the same detector, and light with shorter wavelengths, in particular wavelengths below or just above the excitation wavelength, is reflected from the further dichroic element; the reflected light is guided through a further filter, which does not allow the wavelength of the excitation light to pass, onto a further detector. The intensity or light quantity distributions measured for individual fluorophores are used to localise the fluorophores. To distinguish between fluorophores, bursts detected simultaneously on both detectors are assigned to each other, and the species of fluorophore is deduced from the ratio of the measured intensities or light quantities. This takes advantage of the fact that the proportion of short-wavelength fluorescence with wavelengths below a given excitation wavelength in relation to long-wavelength fluorescence with wavelengths above a given excitation wavelength differs greatly between different fluorophores. The short-wavelength portion is usually so small that a good localisation based on measured intensity or light quantity distributions would hardly be possible. Localisation is therefore only carried out on the basis of the intensity or light quantity distribution of the long-wavelength fluorescence and the measured values of the short-wavelength fluorescence are used exclusively for the identification of the fluorophore species.

In the publication “Visualizing Intracellular Organelle and Cytoskeletal Interactions at Nanoscale Resolution on Millisecond Timescales”, Yuting Guo et al., Cell (2018), https://doi.org/10.1016/j.ce11.2018.09.057, a method for high-resolution imaging using structured illumination is described that is not based on the localisation of individual fluorophores. Images are shown based on the use of three different fluorescent proteins, where biological structures labelled with different fluorophores are imaged with high resolution in their spatial relationship to each other. In addition, it is demonstrated that the method is also suitable for detecting individual fluorophores.

MINFLUX nanoscopy is a localisation microscopy method. The localisation of the fluorophores is carried out by means of structured excitation light distributions. The basic characteristic of MINFLUX nanoscopy is that the excitation of the fluorophores is carried out in such a way that a fluorophore to be localised is always placed close to or in a minimum of the excitation light distribution, which is ideally a zero point, whereby the excitation light distribution adjacent to the minimum has an intensity increase region. This achieves a better utilisation of the fluorescence photons with respect to obtaining information about the position of the respective emitting fluorophore. This also applies to applications in which the movement of fluorophores is to be tracked over time. The observation of a sample using an excitation minimum, the basis of MINFLUX nanoscopy, is known from the patents DE 10 2011 055 367 B4, here initially only for tracking the movement of individual molecules in a sample, and DE 10 2013 114 860 B3. DE 10 2011 055 367 B4 also addresses the possibility of tracking two different fluorophores simultaneously. For this, two different light sources are to be used, which are switched between in rapid alternation.

Based on this, a number of refinements for information retrieval have been developed that allow localisation of the fluorophores with an uncertainty in the range below 2 nm. This size of uncertainty corresponds to the extent of fluorophores. A detailed account of MINFLUX microscopy can be found in “Nanometer resolution imaging and tracking of fluorescent molecules with minimal photon fluxes”, Francisco Balzarotti et. al, arXiv:1611.03401 [physics.optics] (2016). In principle, in order to localise a fluorophore using MINFLUX microscopy, the intensity minimum or the intensity zero must be placed at a plurality of positions relative to the position of the fluorophore. For this, a position of the fluorophore has to be estimated with a first, lower accuracy in a preparatory step. This can be done, for example, by means of ordinary localisation microscopy (PALM, STORM) or by means of other known methods. In the publication mentioned above, a method is described for this purpose in which a sample is scanned with a Gaussian intensity distribution until fluorescence is detected at a scanning position that with a certain probability originates from a singulated molecule. The scanning is then stopped and the intensity distribution is then positioned around the scanning position at a number of locations, specifically four locations, at a distance of less than the wavelength of light from the scanning position. From the photon counts measured at each position, the position of the singulated emitter is estimated to according to a procedure described in the publication. The estimation corresponds in essence to a ratiometric evaluation of the photon numbers detected at the various positions. Subsequently, an intensity distribution of excitation light with a central minimum, for example in the shape of a donut as known from STED microscopy, is placed at a known position chosen such that the fluorophore is close to the minimum of the intensity distribution. The fluorescence response of the fluorophore is measured. The same is repeated for one or more other positions of the intensity distribution. By means of a ratiometric evaluation of the measured intensity or light quantity ratios, the position of the fluorophore is determined with higher accuracy. In principle, the emission rate increases the further the fluorophore is from the excitation minimum or the further the fluorophore is shifted into an intensity increase region. This more precisely determined position can now be used as a starting position for a repetition of the sequence of the aforementioned steps, whereby the plurality of positions can be placed closer to the estimated fluorophore position. Particularly with regard to tracking the movement of fluorophores, the change in emission rate as the fluorophore moves into or towards the minimum of the intensity increase region can also be used to estimate the displacement of the fluorophore with high accuracy. The closer the minimum positions of the intensity distribution are to the actual location of the fluorophore, the fewer fluorescence photons are required for localisation with a given uncertainty or accuracy. The MINFLUX method can also be used for localisation in three dimensions, for example, using so-called bottle beams for excitation.

In particular, the publications WO 2018/069 283 A1, US 2019/0235220 A1, US 2019/0234882 A1 and US 2019/0234879 A1 are to be mentioned as patent publications on MINFLUX microscopy, whereby the aforementioned US patent applications are in each case subsequent applications to the first-mentioned provisional international patent application, in which all concepts mentioned below with reference to the US patent publications are also disclosed.

US 2019/0235220 A1 is directed to a method having a small or minimal number of positions at which an intensity minimum adjacent to both sides of intensity increase regions in each spatial direction in which a location of the fluorophore is to be determined is placed to determine the location of the fluorophore.

US 2019/0234882 A1 is directed to the method described further above, in which the location information obtained from a first MINFLUX step is used to place the minimum of the intensity light distribution closer to the fluorophore in each case in a subsequent step and to derive more precise location information therefrom.

US 2019/0234879 A1 is directed to a method in which the intensity minimum is placed very quickly, quasi simultaneously, at a plurality of positions around the estimated location of the fluorophore. A single position is then moved closer to the supposed minimum if an increased emission rate is detected at it.

In the publication “MINFLUX monitors rapid molecular jumps with superior spatiotemporal resolution”, Yvan Eilers et. al, Proceedings of the National Academy of Sciences, 115 (24) 6117-6122, (2018); https://doi.org/10.1073/pnas.1801672115, it is described in particular how MINFLUX can be used to track the movement of single molecules with a resolution of movement in the range of a few nanometres. In the outlook, it is mentioned that multi-color applications of MINFLUX technology are foreseeable. However, no concrete details are given on this.

The publication “MINFLUX nanoscopy delivers 3D multicolor nanometer resolution in cells”, Klaus C. Gwosch et. al, Nat Methods 17, 217-224 (2020), https://doi.org/10.1038/s41592-019-0688-0, focuses on three-dimensional nanoscopy with several different fluorophores. The publication also documents the proof that by means of the iterative approximation of the minimum positions to the actual location of the fluorophore in question, a reduction in the uncertainty of the localisation is achieved compared to a ratiometric localisation with fixed minimum positions. It is further shown that in this way an isotropic resolution in three dimensions is achieved. It is demonstrated that MINFLUX nanoscopy can also be performed using photoactivatable fluorescent proteins, specifically mMaple, especially on living cells. For imaging using different fluorophores, dyes are used that have a large mutual overlap of spectral absorption curves and can thus be excited with one and the same excitation wavelength. Specifically, three-dimensional nanoscopy is shown with two different fluorophores each, using a total of two different pairs (A: CF660C and Alexa Fluor 647; B: CF680C and Alexa Fluor 647), with one partner of the pair being the dye Alexa Fluor 647 in both pairs. In the MINFLUX image, the same laser is used to excite both dyes of a pair. In addition, a MINFLUX image of nuclear pores of living cells is shown for which the fluorescence of Nup96-mMaple expressed by the appropriately modified cell, i.e. only one dye, is used. The experimental setup has two different lasers for excitation with an excitation donut, one with a wavelength of 642 nm, which is suitable for excitation of the above-mentioned dye pairs, and one with a wavelength of 560 nm, which is suitable for excitation of Nup96-mMaple. The two dyes of each pair differ in their emission characteristics. The detection path of the nanoscopy arrangement used is divided by means of a dichroic beam splitter into a spectral detection channel for light of a wavelength above 685 nm and one for light of a wavelength below 685 nm. When performing the measurement, since the spectral emission curve of all fluorophores used is clearly not equal to 0 (zero) both above and below the cut-off wavelength, light is detected in both spectral channels for all fluorophores used. The sum signal is used for the localisation of the fluorophore. Since regularly only one fluorophore fluoresces in the localisation area, apart from background fluorescence, and since the different fluorophores of a pair differ in spectral emission, it can be deduced in each case from the ratio of the signals in the different detection channels which fluorophore species of the dye pair caused the signal. As a result, a specific dye can be assigned to each localisation. Possible misassignments are minimised in a data analysis by means of a principal component analysis of the spectral components of all MINFLUX iterations. Since the localisation is based on the knowledge of the positions of the minima of the intensity distributions of the excitation light alone, there is no color-dependent offset between localisations of the different fluorophores, since they are excited with identical excitation wavelengths. In the publication, it is mentioned as significant that, since the fluorophores are only markers for biological structures to be imaged, the resolution of the imaging of biological structures achieved by MINFLUX nanoscopy is ultimately determined by the size of the fluorophores used. In order to fully utilise the potential of MINFLUX nanoscopy, the fluorescence labelling must therefore be optimised, taking into account the size and orientation of the fluorophores. The advantage of MINFLUX nanoscopy is that fewer photons are needed for exact localisation, so that a larger selection of fluorophores can be used for MINFLUX.

A procedure essentially identical to that in the above publication is discussed for the examination of other samples in the paper “Multicolor 3D MINFLUX nanoscopy of mitochondrial MICOS proteins”, Jasmin Pape et. al, PNAS, 117 (34) 20607-20614, (2020), https://doi.org/10.1073/pnas.2009364117.

In the European patent application publication EP 3 372 990 A1, in addition to other MINFLUX methods, a method similar in one aspect to the MINFLUX method is described. As in a MINFLUX method, a focused intensity distribution is applied to a singulated molecule, which has a central minimum, preferably a zero, and increase regions surrounding this; also as in MINFLUX, this minimum is placed at a plurality of scanning points around the presumed location of the singulated molecule and a fluorescence emission is detected for each scanning point; the actual position is estimated with high precision from the intensity values or photon numbers thus obtained. In contrast to MINFLUX, the intensity distribution is a distribution of fluorescence prevention light, especially STED light. This is applied together with excitation light, whereby the intensity distribution of the excitation light has no central local minimum. While in MINFLUX the fluorescence emission is higher when the singulated molecule is further away from the central minimum of the intensity distribution, in this method it is the other way round. This method, like the MINFLUX methods described in the paper, is aimed at measurements on multiply stained nanostructures, whereby the staining is chosen in such a way that different fluorophores that are spatially closer than one resolution limit can be distinguished. This can be ensured, for example, by using fluorophores that are excited with mutually different excitation wavelengths.

In the publication “MINSTED fluorescence localisation and nanoscopy”, Michael Weber et al., bioRxiv 2020.10.31.363424; doi: https://doi.org/10.1101/2020.10.31.363424, a variant of the MINFLUX-like localisation method mentioned above is described. For the localisation of isolated fluorophores, an intensity distribution of a STED light with a central intensity minimum is superimposed with a Gaussian intensity distribution of an excitation light. At the beginning of localisation, a low STED intensity is used, resulting in an effective excitation spread function that is only slightly narrowed compared to a simple excitation. The superimposed intensity distributions are guided on a circular path around the location of a single fluorophore estimated from a pre-localisation, while a detector is set up to detect fluorescence photons emitted from the circularly scanned area. If a photon is now detected, the centre of the circular path is shifted towards the location where the centre of the superimposed light distributions was located when the photon was emitted by a value that is a fraction of the radius of the original circular path. At the same time, the STED intensity is increased so that the half-width of the effective excitation spread function is reduced. This procedure is continued iteratively, but the increase in STED intensity is stopped at a fixed value, so that in later steps, if necessary, the centre of the circular path is shifted without simultaneously increasing the STED intensity. The position of the centre of the circular path thereby approaches more and more the position of the fluorophore to be localised. The iterations are terminated when the singulated fluorophore no longer emits any photons. Like MINFLUX, this method also offers excellent utilisation of the information contained in the detected photons. The publication announces that several color channels are to be made possible by using spectrally shifted fluorophores. The method is said to be particularly suitable for tracking emitters moving rapidly in a sample. The authors call the proposed method MINSTED.

Using MINFLUX nanoscopy, the position of fluorophores in two spatial directions could be determined experimentally with an uncertainty of only 1 nm, i.e. the accuracy of the position determination is comparable to the extent of the fluorophores themselves. If the position of a single fluorophore is to be determined with a given measurement uncertainty, a shorter time and, in particular, a smaller number of fluorescence photons are required for this than for a position determination of a single fluorophore by means of conventional localisation microscopy. Similar applies to MINSTED nanoscopy.

All prior art localisation microscopy methods have the disadvantage that imaging of multiply stained samples is only possible if the fluorophore pairs are specifically selected with regard to the chosen imaging method. This makes it difficult to select fluorophores that are optimally matched to the structures to be imaged.

### Objective of the Present Disclosure

Accordingly, it is the object of the present disclosure to provide methods and devices of localisation microscopy for the examination of samples, which are stained with multiple dyes, which improve the imaging of samples stained with multiple dyes or the tracking of the movement of individual fluorescent molecules in samples stained with multiple dyes in that they facilitate the selection of fluorophores matched to the sample to be examined.

### Solution

The object of the present disclosure is solved by a localisation microscopic method for an examination of a sample stained with multiple dyes having the features of independent patent claim 1 and by a further localisation microscopic method for an examination of a sample stained with multiple dyes having the features of independent patent claim 21. Dependent claims 2 to 20 relate to preferred embodiments of the method according to patent claim 1, and dependent claims 22 to 32 relate to preferred embodiments of the method according to patent claim 21. The object is further solved by a microscope which is set up for carrying out a method according to the present disclosure, in particular to carry out the method of claim 1 or the the method of claim 21 and having the further features of patent claim 33 or patent claim 34 respectively. These and further solutions of this object are described in more detail in the following text.

### DESCRIPTION OF THE PRESENT DISCLOSURE

In the context of this application, certain terms are used whose meaning should be clarified at the beginning. Localisation microscopic methods are understood to be all those methods in which knowledge of the position of an emitter is based at least also on the knowledge that the emitter was present in a singulated manner. This includes methods typically carried out in the wide-field, such as PALM or STORM, as well as methods of structured illumination microscopy, insofar as these are carried out on singulated emitters. This also includes the MINFLUX and STED localisation methods mentioned below, as well as methods in which localisation is carried out using the displacement of a focused excitation light distribution with a central intensity maximum within a small-field area.

In the context of this application, MINFLUX methods are understood to be those methods in which localisation is performed according to one of the MINFLUX methods known from the prior art using an excitation light distribution with a local, mostly a central, intensity minimum, i.e. an intensity minimum lying on the optical axis. For example, an excitation light distribution with a central minimum can either be moved together with a distribution of fluorescence prevention light with a central minimum, or the central minimum of an excitation light distribution is moved within a range around a minimum of a distribution of fluorescence prevention light.

In the context of this application, STED localisation methods are understood to be those methods in which localisation is performed according to one of the MINFLUX-like methods known in the prior art or according to a MINSTED method also known in the prior art using a fluorescence prevention light distribution, the influence of the fluorescence prevention light distribution being essential for localisation. For example, an excitation light distribution having a central maximum can either be moved together with a distribution of fluorescence prevention light having a central minimum, or the central minimum of a fluorescence prevention light distribution is moved within a range around a maximum of a distribution of excitation light. In this application, the term MINSTED is also applied to those methods in which localisation is terminated before the singulated emitter has lost its excitability, or in which there is no threshold for a maximum STED intensity above which the intensity of the STED light is not further increased, or in which the half-width of the effective excitation spread function is changed by measures other than an increase in STED intensity, and in each case also those in which the fluorescence prevention light is not STED light.

The task underlying the present disclosure is first solved by a first localisation microscopic method for an examination of a sample stained with several dyes, which is described below.

This method according to the present disclosure first comprises a first exciting and detecting, wherein a partial area of the sample is exposed to excitation light of a first wavelength and wherein fluorescent light emitted from a singulated molecule of a dye is detected from the partial area of the sample as a result of the excitation with the excitation light of the first wavelength and a first detection signal is obtained. The detection signal comprises a value that is representative of the amount of fluorescent light detected. This value is subsequently referred to as the light quantity value. Exciting and detecting can be performed in such a way that a first localisation of a single excitable fluorophore can be obtained directly. In any case, the method comprises a first localising of the singulated molecule based on the first detection signal and obtaining a first localisation.

It further comprises a second exciting and detecting, wherein the partial area of the sample is exposed to excitation light of a second wavelength and wherein fluorescent light emitted from the partial area of the sample as a result of the excitation with the excitation light of the second wavelength by the singulated molecule of the dye is detected and a second detection signal is obtained. This second detection signal comprises a light quantity value. The second exciting and detecting is performed in such a way that it is a second localising of the singulated molecule and that a second localisation is obtained based on the second detection signal. This second localisation does not necessarily have to be obtained after the first localisation. It is called a second localisation because it is obtained using excitation light of a second wavelength.

Finally, the method comprises determining a difference between the first localisation and the second localisation. The difference thus determined may be used in imaging samples stained with multiple dyes to enable co-localisation or co-registration of the multiple dyes in a common spatial reference system.

In a preferred embodiment, the partial area of the sample is a small-field area. A small-field area is understood to be an area that is only slightly larger than results from the measure of diffraction-limited separability of structures in the sample. For example, a small-field area may have an extension of less than 3 μm, preferably of less than 2 μm, further preferably of less than 1.5 μm, the small-field area having the corresponding extent in one, but preferably in two or three spatial directions, i.e. being related to a localising in two or three spatial directions.

If the partial area is a small-field area, the exciting and detecting are preferably each performed using focused excitation light. This means that both the excitation light of the first wavelength and the excitation light of the second wavelength are irradiated into the small-field area in a focused to manner.

In a preferred embodiment of the present disclosure, in which the partial area is a small-field area, the first exciting and detecting is performed with focused excitation light of the first wavelength, which has an intensity distribution with a central minimum in the focal area, which is in particular essentially a donut distribution or a bottle-beam distribution. The focal point, which here coincides with the centre of the central minimum, is thereby positioned at a location within the partial area. How such a partial area, i.e. a small-field area with a singulated excitable fluorophore, can be found is known from the prior art. The preferred embodiment of the first method according to the present disclosure described here has the advantage that with the intensity distribution with a central minimum both a finding of a small-field area with a singulated excitable fluorophore and a subsequent highly accurate localising with a MINFLUX method are particularly well possible. Advantageously, neither a special light source nor a change in the intensity distribution is required for the detection. For example, for the finding the excitation light can be guided over the sample in spiral paths until in a partial area of the sample a fluorescence quantity is detected per period of time, which indicates the presence of a singulated excitable fluorophore. The spiral scanning can now be terminated at the corresponding point. The focal point is then positioned at a location within the partial area, as written above. Likewise, a light quantity value is also obtained directly, which corresponds to the amount of fluorescence detected during the finding.

A first localisation can be obtained by continuing the exciting with the first wavelength and the associated detecting after stopping the spiral motion, while detecting the fluorescent light in a plane conjugate to the plane in which the focal point is located, i.e. confocal, with a spatially resolving detector or while positioning a detection aperture within a plane oriented perpendicular to an optical axis at a plurality of positions around the optical axis. The signal detected in the confocal plane is then dependent on location in this plane, the location dependence being dependent on the position of the singulated excitable fluorophore relative to the focal point of excitation. A localisation can thus be obtained for the fluorophore. Compared to a localisation using a MINFLUX method, this has a high uncertainty. However, the achievable accuracy is sufficient to subsequently start a MINFLUX localising, for example. In conjunction with further information, it may also be sufficient to enable co-localisation or co-registration of the multiple dyes in a common spatial reference system.

An alternative possibility, which is well suited to closely link the finding of the small field area with the singulated excitable fluorophore to the first exciting with the first wavelength, is that the intensity distribution of the focused light of the first wavelength has a central maximum, in particular is substantially a Gaussian distribution, and that the first exciting and detecting, wherein a partial area of the sample is exposed to excitation light of the first wavelength, is performed by positioning the focal point of the excitation light of the first wavelength at a sequence of locations within the partial area. As in the embodiment described above, a detection signal having a light quantity value is obtained. From the partial detection signals obtained at the sequence of locations within the partial area, a first localisation can be obtained.

For example, the first exciting and detecting may be terminated after a predetermined period of time. Alternatively, the first exciting and detecting can be terminated when a light quantity value of the first detection signal has reached a threshold value, i.e. when a minimum number of fluorescence photons or a minimum light quantity has been detected. Other criteria may also be defined, and when these are met, the first exciting and detecting is terminated. For example, during exciting, the detection signal can be examined while it is still being fully recorded to determine whether a certain ratio to a background has been reached. A background can, for example, be measured with an additional detection device.

The intensity distribution of the focused light of the second wavelength preferably has a central minimum, it is in particular essentially a donut distribution or a bottle-beam distribution as known respectively from STED microscopy. The second exciting is then preferably performed by positioning the focal point of the excitation light of the second wavelength at a sequence of nominal locations enclosing the first localisation as a reference point, i.e. as a central point, within the partial area, the enclosed area having a first extent. This sequence of locations may have a certain number of locations, but it may also be a continuous sequence of locations. That the area of the first location is enclosed also includes that the first location is included in the sequence of nominal locations. The locations are referred to as nominal locations because an offset of the focal points of the excitation light distributions, which may be present due to the different excitation wavelengths, is not well known prior to performing the method. The device with which the method is carried out can therefore be set, for example, as if no offset occurs, naturally taking into account, for example, already existing calibration values. Then the actual focal points in the sample deviate from the nominal focal points by approximately the value for the offset, which can be the one remaining even after taking calibration values into account.

In further preferred embodiments, in which finally a small-field area is investigated with a small-field method, further steps mentioned below are carried out. On the basis of one of the detection signals or on the basis of both detection signals, a wavelength is selected with which the singulated fluorophore is to be further localised. The selected wavelength can be chosen from the first or second wavelength for which a detection signal has already been obtained, or a further wavelength can be selected if the microscope provides more than two excitation wavelengths. The light of the selected wavelength is then used for further exciting within the small-field area of the sample, whereby fluorescent light emitted by the singulated molecule of the dye is detected from the partial area of the sample as a result of excitation with the excitation light of the selected wavelength and a further detection signal is obtained. A further localisation is then obtained for the singulated molecule based on the further detection signal. For example, if a small-field area is illuminated with focused light of the further wavelength, which stays at a focal point, and the detecting is performed with a confocally arranged detector that locally resolves a diffraction image in the confocal plane, a localisation can be determined from the detection signal. In a preferred method, the exciting with the further wavelength is performed by placing the focal point at a sequence of locations enclosing the location of the singulated fluorophore assumed on the basis of the information obtained earlier in the process, i.e. the exciting and detecting is carried out altogether as as a localising.

Selecting of the wavelength is preferably done by evaluating the first or the second detection signal or both detection signals. This evaluation can, for example, be directed towards determining the dye species of the singulated fluorophore that has emitted the detected fluorescent light. For example, the amount of light received per time at only one wavelength can be used to determine whether the singlated fluorophore was strongly or weakly excited. One or more reference values can also be stored, with which one detection signal or both can be compared. A preferred method relies on a comparison of the two detection signals, which in many cases is a good indicator of the fluorophore species. For example, if the amount of light received per time of one detection signal is a multiple of that of the other detection signal, the wavelength of the stronger signal can also be selected without the intermediate step of inferring the fluorophore species. The selected wavelength can then be the first wavelength or the second wavelength.

However, another wavelength can also be selected that differs from both the first wavelength and the second wavelength. This may be particularly useful in cases where fluorophores of one species are to be localised in the sample, which cannot be localised sufficiently well to be able to achieve the goal of co-localisation with wavelengths with which fluorophores of another species contained in the sample can be localised well. If such a further wavelength is selected, then the method also comprises determining a difference between the first localisation and the further localisation obtained with the further wavelength or the second localisation and this further localisation, or determining both of these differences. Preferably, the light of the further wavelength is focused light. It further preferably has an intensity distribution with a central minimum in the focal region. This intensity distribution may preferably be a donut distribution or a bottle beam distribution. Further exciting and detecting can then be performed in all the ways described above with regard to the second exciting and detecting. The reference point may be calculated from the first or the second localisation or from the first and the second localisation, whereby the first localisation can only be taken into account if it has already been obtained. Preferably, the reference point is determined from the first localisation or is directly given by the first localisation if the selected wavelength is the first wavelength. Accordingly, the reference point is preferably determined from the second localisation or is directly given by the second localisation if the selected wavelength is the second wavelength. If the selected wavelength is a further wavelength that lies between the first and second wavelengths, the reference point can be determined by interpolation from the first and second localisations, and if the selected wavelength is a further wavelength that is greater than the first and second wavelengths or less than the first and second wavelengths, it can be determined by extrapolation from the first and second localisations.

It has already been pointed out that the first exciting and detecting is not necessarily associated with a first localising. In particular, in such a case, the first localising occurs after selecting of a wavelength. Then the selected wavelength is the first wavelength and the further localising is the first localising. The further exciting and detecting and the further, that is the first, localising of the singulated fluorophore are then preferably performed contiguously or iteratively until a further localisation with at most a predetermined uncertainty is obtained, which is then the first localisation. In such a case, the second exciting and detecting and the second localising take place not until the termination of the further exciting and detecting.

In order to obtain an image of the multiply stained sample or a region of the sample, for example a specific biological structure, one of the processes carried out in the small-field can be repeated or performed in parallel on different singulated fluorophores. In this case, an image in which the multiple staining contributes to the information gain can be obtained if in total singulated fluorophores of the multiple fluorophore species are localised. For this purpose, a total of multiple small-field areas must be investigated, which, however, preferably overlap and, if the structure to be investigated is itself very small, also together form a small-field area. One of the small-field methods is then carried out for a multitude of partial areas, i.e. small-field areas of the sample, whereby the multitude of partial areas contains both partial areas from which fluorescent light was emitted and detected by a singulated fluorophore of a first dye and those from which fluorescent light was emitted and detected by a singulated fluorophore of another dye.

The differences determined in each case between the localisations, i.e. between the first and the second or between the first and the second and the further, can be used to transfer all localisations into a common reference system, i.e. to obtain a co-localisation for singulated fluorophores of different species. For this purpose, a map with correction vectors for the co-registration of all localisations in a common spatial reference system preferably be determined from the localisations and the differences of the localisations of the individual singulated fluorophores obtained with excitation light of different wavelengths. Preferably, for each of the localisations, information is stored about the time at which the exciting and detecting for the localising occurred. This information can then be included in the respective detection signal. The map with correction vectors can then be a map dependent on a time coordinate. The correction vectors may each correspond to mean values over several or many differences. If the sample or the properties of the imaging of the sample vary in time, it is advantageous to form such mean values over differences obtained in close temporal proximity. Accordingly, in the case of spatial variability, averaging can be done over close spatial neighbourhoods. In order to correct, for example, longer-term temporal drifts in the image, i.e. here in the image stack, methods known from the state of the art are then available. Either active stabilisation can be performed, in which case the relative drifts of the color channels to each other are the essential correction that can be corrected by means of the present disclosure, or post-processing can be performed, which is based on improved basic data if methods according to the present disclosure have been used.

In principle, all obtained localisations and all determined differences can be used for image acquisition. An image of the sample can thus be generated from the first and the second localisations and/or the first and the further localisations and/or the second and the further localisations and optionally from other localisations obtained by means of exciting with excitation light of the first wavelength or the second wavelength or one of the further wavelengths and detecting.

Also when using a small-field method, in principle the first exciting and detecting and the second exciting and detecting can take place in the same or overlapping time spans. Preferably, however, when using a small-field method, it is carried out in different time spans, which further preferably do not overlap. The first exciting and detecting takes place before the second exciting and detecting. This does not exclude, as written above, that the first localising takes place after the second exciting and detecting.

The first method according to the present disclosure can also be carried out in the wide-field. In this case, the partial area of the sample is a wide-field area and the detecting is an imaging of the partial area onto a wide-field detector, whereby fluorescent light emitted by the isolated molecule is detected on the wide-field detector in a locally resolved manner, so that a locally resolved detection signal is obtained. Wide-field methods advantageously enable the simultaneous localisation of multiple or many isolated fluorophores in a comparatively simple manner. During the first exciting and detecting and the second exciting and detecting, fluorescent light emitted by a plurality of singulated molecules from the partial area of the sample as a result of excitation with excitation light of the respective wavelength is then detected, and a first and a second spatially resolved detection signal is obtained for a plurality of singulated molecules, respectively. The first and second localising of a plurality of singulated molecules, i.e. fluorophores, is then performed on the basis of the respective first and second spatially resolved detection signals, from which the first and second localisations are obtained respectively. How localisation is performed from wide-field data is known to the skilled person. Localisation in wide-field methods is finally an analysis of image data, whereas in some of the aforementioned small-field methods, localisation is a process comprising scanning in a particular manner. If a method according to the present disclosure is carried out in the wide-field, then at least one determining of a difference between the first localisation and the second localisation is carried out in each case.

Even when using wide-field methods, the first and/or the second detection signal can be used to determine which dye the singulated molecule belongs to for the multiple singulated molecules from which emitted fluorescent light was detected. When using wide-field methods, the first exciting and detecting and the second exciting and detecting can preferably be performed simultaneously. This is useful if detectors are available for the detection that detect in different spectral channels. Even with wide-field methods, the first exciting and detecting can be terminated to after a predetermined period of time. Another wavelength can also be selected for further exciting and detecting. This is then preferably done from a predetermined set of at least two wavelengths. Following the selecting, the further exciting and detecting then takes place, wherein the partial area of the sample is exposed to excitation light of the selected wavelength and wherein fluorescent light emitted from the partial area of the sample as a result of the excitation with the excitation light of the selected wavelength by a plurality of singulated molecules is detected and a further detection signal is obtained in each case. A further localising of the multiple singulated molecules is then carried out on the basis of the further detection signal in each case, so that a further localisation is obtained in each case for multiple singulated fluorophores. In doing so, it is not necessary that a localisation is actually obtained for all singulated fluorophores that have been excited.

When using a wide-field method, selecting of the wavelength can preferably be carried out by evaluating the amount of the first and second detection signals with respect to the species of the dye whose singulated molecules emitted the detected fluorescent light that caused the majority of the amount of detection signals obtained. Even without an analysis with regard to the species of the dye, a selecting can be carried out, for example by investigating at which excitation wavelength more fluorescence of singulated fluorophores is observed. Again, the selected wavelength may not only be the first or the second wavelength, but it may also be another wavelength different from the first and the second wavelength. Then the first method according to the present disclosure comprises determining in each case a difference between the respective first localisation and the respective further localisation and/or in each case between the respective second localisation and the respective further localisation.

Furthermore, the task underlying the present disclosure is solved by a second localisation microscopic method for an examination of a sample stained with multiple dyes, which is now described below.

The second method comprises a testwise exciting and detecting, wherein a partial area of the sample is exposed to excitation light of a test wavelength and wherein fluorescent light emitted from a singulated fluorophore is detected from the partial area of the sample as a result of the excitation with the excitation light of the test wavelength and a test detection signal is obtained.

On the basis of this test signal, optionally supported by further information such as a second test signal, in an alternative selecting of a first wavelength from a predetermined set of at least two wavelengths is carried out for a subsequent exciting of the partial area of the sample. With light of this selected first wavelength, a first exciting and detecting takes place, wherein the partial area of the sample is exposed to excitation light of the first wavelength and wherein fluorescent light emitted from the partial region of the sample as a result of the excitation with the excitation light of the first wavelength by the singulated molecule is detected and a first detection signal is obtained. The singulated excitable fluorophore is localised on the basis of the first detection signal so that a first localisation is obtained. In a preferred embodiment, the first wavelength is selected based on two test detection signals. In this alternative, prior to the selecting and after the testwise exciting and detecting, a second testwise exciting is performed, wherein the partial area of the sample is exposed to excitation light of a second test wavelength and wherein fluorescent light emitted from a singulated molecule is detected from the partial area of the sample as a result of the excitation with the excitation light of the second test wavelength and a second test detection signal is obtained.

In another alternative, a small-field area is selected on the basis of the test signal for a subsequent exciting of the partial area, i.e. a small-field area in which the subsequent exciting and detecting is carried out. In this case, the wavelength with which the subsequent exciting and detecting is carried out can be determined in advance. This then takes the place of the selected wavelength of the first alternative. However, the alternatives are not mutually exclusive. Rather, it is possible that both a small-field range and a wavelength are selected.

Regardless of whether one or two test detection signals are determined, each test detection signal may be a value representative of the amount of fluorescent light detected. The selecting of the first wavelength may be based on the ratio of the first test signal to the second test signal when two test detection signals are determined. It may also be based on a comparison of the first test detection signal, the second test detection signal, or the first and second test detection signals to a predetermined reference value or predetermined reference values. The test wavelengths may each be wavelengths used for localising according to the method, that is, both the first test wavelength and the second test wavelength may be a wavelength included in the predetermined set of wavelengths for exciting.

This method is not initially characterised by the feature of determining a difference between two localisations. Nor is it characterised by a second localisation with a second wavelength. Even without these features, a decisive advantage is achieved. For example, if a movement of structures marked with fluorophores in a multiply stained sample is to be tracked, the method allows a wavelength particularly suitable for tracking to be selected. Also, when tracking a structure, a localising can be performed with the first wavelength each time, with new localisations being determined over time using the same fluorophore.

Following the testwise exciting and detecting, however, selecting of a second wavelength from a predetermined set of at least two wavelengths for a subsequent exciting of the partial area of the sample and a second exciting and detecting can also take place in this second method according to the present disclosure. In this process, the partial area of the sample is exposed to excitation light of the second wavelength and fluorescent light emitted from the partial area of the sample as a result of the excitation with the excitation light of the second wavelength by the singulated molecule is detected so that a second detection signal is obtained. Based on this detection signal, a second localising of the singulated fluorophore is performed, so that a second localisation is obtained. Finally, a difference between the first localisation and the second localisation can also be determined in the second method according to the present disclosure. If a second exciting and detecting with a second wavelength is carried out in the second method according to the present disclosure, most of the advantages of the first method can thus also be realised.

Like the first method, the second method can also be carried out not only as a wide-field method, but also completely as a small-field method. In this case, by default the partial area of the sample is a small-field area, which has an extension of 3 μm or less than 2 μm, for example. However, the second method can preferably also be carried out in that the testwise exciting and detecting, in this case both the first and the optional second, are carried out independently of each other in a wide-field method, while the first or the second or the first and second localising are each carried out in a small-field method. If this is the case, then after the test detection, a small-field area is selected in which the first or the first and second localising is then carried out.

Preferably, in both the first and the second method according to the present disclosure, the first localising is performed according to a MINFLUX method, a MINSTED method or a STED localisation method. A MINSTED method is particularly advantageous when the first localising is used in the context of tracking a fluorescently marked structure. The second method can also be used in the context of imaging structures in a sample, even if the localising is performed in a small-field. In this case, this method is also carried out for a multitude of partial areas of the sample, so that the multitude or set of partial areas finally examined contains both partial areas from which fluorescent light was emitted and detected by a singulated molecule of a first dye and those from which fluorescent light was emitted and detected by a singulated molecule of another dye.

As in the first method, also in the second method a map with correction vectors for the co-registration of all localisations in a common spatial reference system can be determined from the localisations and the differences of the localisations of the individual singulated molecules obtained with excitation light of different wavelengths. This is also true in that for each of the localisations, information can be stored about the time at which the exciting and detecting for localising took place, and that the map with correction vectors can be a map dependent on a time coordinate. Similarly, an image of the sample can be generated from the first and second and optionally from other localisations obtained by exciting with excitation light of the first wavelength or the second wavelength.

Furthermore, the task underlying the present disclosure is solved by a third localisation microscopic method for an examination of a sample stained with multiple dyes, which is now described below.

This third method according to the present disclosure first comprises a first exciting and detecting, wherein a partial area of the sample, the partial area being a small-field area, is exposed to focused excitation light of a first wavelength, positioning the focal point of the excitation light of the first wavelength at a sequence of locations within the partial area, and wherein light emitted from a singulated bead is detected from the partial area of the sample as a result of the excitation with the excitation light of the first wavelength for the sequence of locations. By evaluating the sequence of locations and the detected light at the sequence of locations within the partial area, a first localisation of the bead is obtained.

It further comprises a second exciting and detecting, wherein a partial area of the sample, the partial area being a small-field area, is exposed to focused excitation light of a second wavelength, positioning the focal point of the excitation light of the second wavelength at a sequence of locations within the partial area, and wherein light emitted from a singulated bead is detected from the partial area of the sample as a result of the excitation with the excitation light of the second wavelength for the corresponding sequence of locations. By evaluating the sequence of locations and the detected light at the sequence of locations within the partial area, a second localisation of the bead is obtained. This second localisation does not necessarily have to be obtained after the first localisation. It is called a second localisation because it is obtained using excitation light of a second wavelength.

Further, the method comprises determining a difference between the first localisation and the second localisation. The difference thus determined may be used in imaging samples stained with multiple dyes to enable co-localisation or co-registration of the multiple dyes in a common spatial reference system.

In a preferred embodiment of the third method the first exciting and detecting or the second exciting and detecting or as well the first exciting and detecting and the second exciting and detecting is performed with focused excitation light, which has an intensity distribution with a central minimum in the focal area, which in particular essentially may be a donut distribution or a bottle-beam distribution. The focal point may coincide with the centre of the central minimum. This means, that in this preferred embodiment the first localisation or the second localisation or both are obtained according to a MINFLUX-method. Preferably the first exciting and detecting and the second exciting and detecting is performed with focused excitation light, which has an intensity distribution with a central minimum in the focal area, and both localisations are obtained according to a MINFLUX-method.

The bead may be a fluorescent bead or preferably a reflective bead. Preferably the extent of the bead is less than 200 nm, more preferably less than 150 nm, particularly less than 100 nm. Reflective beads have the advantage not to leach out. Another advantage of reflective beads is, that they emit only light of the wavelength with which they are excited, so that their emission is filtered out easily when detecting fluorescent light of fluorescent emitters to be localised, e.g. by a MINFLUX-method.

The third method can be repeated for a number of beads. In this way in the third method a map with correction vectors for the co-registration of localisations in a common spatial reference system can be determined from the localisations and the differences of the localisations of the individual beads obtained with excitation light of different wavelengths.

The third method can be repeated for one or for a number of beads at different times during an the process of imaging a sample or a partial area of a sample. Repeating the method at different times as well as for a number of beads may result in a time-dependent map of correction vectors for the co-registration of localisations in a common spatial reference system.

In a preferred embodiment a map with correction vectors obtained by the third method is used for the co-registration of localisations of singulated fluorophores in a common spatial reference system.

Finally, the problem underlying the present disclosure is solved by a microscope according to the present disclosure. The microscope is arranged for carrying out a method according to the present disclosure, in particular for carrying out a method in which selecting of a wavelength is carried out. The microscope comprises a laser unit for the excitation of fluorescence, which is arranged to emit narrowband light of two wavelengths, or two laser units for the excitation of fluorescence, which together are arranged to emit narrowband light of two wavelengths. It further comprises a detection unit and a selection unit arranged to select a wavelength for excitation based on a detection signal relating to fluorescence emission from a single fluorophore. Furthermore, it comprises a calculation unit which is arranged to determine a localisation and a difference of localisations from two detection signals with respect to a fluorescence emission of a single fluorophore, respectively. Preferably, the microscope can provide excitation light of two wavelengths that differ from each other by a value between 200 nm and 50 nm. Further preferably, the microscope comprises a laser unit arranged to emit narrowband light of a third wavelength. This does not exclude that it comprises a laser unit arranged to emit excitation light of a total of the wavelengths satisfying the above-mentioned conditions with respect to each other. Further preferably, the microscope comprises one or more STED lasers. Preferably, it comprises a control unit which is preferably arranged to perform a MINFLUX method, a STED localisation method or a MINSTED method. Further advantageous features of the microscope according to the present disclosure result in particular from the details mentioned with regard to the methods.

In general, MINFLUX microscopy is performed using a control device based on a field programmable gate array (FPGA). These controllers are well suited to quickly control fixed measurement sequences, provided that these sequences depend on rather few conditions that are checked during the measurement. The more complex the decisions to be made during the measurement sequence become, the more difficult the FPGA programming becomes. In terms of programming effort, microprocessors offer advantages here. MINFLUX microscopy for the examination of multiply stained samples according to the present disclosure is a quite complex procedure. Because of this, a MINFLUX-microscope which is adapted to perform complex tasks, particularly to perform embodiments of the methods according to this disclosure, includes a controller comprising a microprocessor for controlling a MINFLUX-measurement. The microprocessor can be integral part of an FPGA. Alternatively the controller does not include an FPGA at all, this means the controller is a microprocessor. Preferably the microprocessor operates using a real time operating system.

Advantageous enhancements of the present disclosure are apparent from the patent claims, the description and the drawings and the accompanying explanations to the drawings. Some of the drawings are flowcharts, by means of which the processes according to the present disclosure are explained in great detail.

The claims are not to be understood to limit the present disclosure. Rather, further solutions and enhancements may result from features mentioned in the description as well as from the drawings and the accompanying explanations, which may have an effect individually or cumulatively. In particular, many features which are explained in this submitted version only with regard to one of the two methods according to claim 1 or according to claim 21 are also features of advantageous enhancements of the respective other method according to the present disclosure.

### BRIEF DESCRIPTION OF THE FIGURES

FIG. 1 shows absorption and emission spectra of two fluorescent dyes suitable for carrying out the methods according to the present disclosure.

FIG. 2 shows a flow chart of the first method according to the present disclosure.

FIG. 3 shows a flow chart of an implementation of a first embodiment of the first method according to the present disclosure, in which exciting and detecting take place in a small-field area.

FIG. 4 shows a flowchart of another embodiment of the first method according to the present disclosure, also shown in FIG. 3.

FIG. 5 shows a flow chart of a further embodiment of the first method according to the present disclosure.

FIG. 6 shows a flow chart of steps that can be carried out in multiple of the embodiments of both methods according to the present disclosure.

FIG. 7 is a schematic representation for selecting of a wavelength from a set of wavelengths.

FIG. 8 illustrates that each step of exciting and detecting comprises the two elements of exciting and detecting.

FIG. 9 shows a flow chart of a further embodiment of the first method according to the present disclosure with a selecting of a further wavelength.

FIG. 10 shows a flow chart of a first embodiment of the second method according to the present disclosure.

FIG. 11 shows a flow chart of a second embodiment of the second method according to the present disclosure with a selecting of a small-field area.

FIG. 12 shows a partial area of a multiply stained sample with a small-field area with a singulated excitable fluorophore and further excitable fluorophores.

FIG. 13 shows a flow chart of an embodiment of the second method according to the present disclosure, in which testwise exciting and detecting is carried out with two test wavelengths.

FIG. 14 shows a flowchart of a further embodiment of the second method according to the present disclosure, in which testwise exciting and detecting is performed with two test wavelengths with a selecting of a small-field area.

FIG. 15 shows a flow chart of an embodiment of the second method according to the present disclosure with obtaining a first and a second localisation and obtaining a difference of the localisations by a comparison.

FIG. 16 shows a schematic illustrating how co-localisation of different fluorophores in a common spatial reference system is possible.

FIG. 17 shows another schematic illustrating how co-localisation of different fluorophores in a common spatial reference system is possible.

FIG. 18 shows a further schematic illustrating how co-localisation of different fluorophores in a common spatial reference system is possible.

FIG. 19 shows a scheme regarding the co-localisation of more than two dye species.

FIG. 20 schematically shows a microscope according to the present disclosure.

### DESCRIPTION OF THE FIGURES AND EXPLANATION OF THE PRESENT DISCLOSURE ON THE BASIS OF THE FIGURES

In the following, the present disclosure is further explained and described with reference to the embodiments shown in the figures.

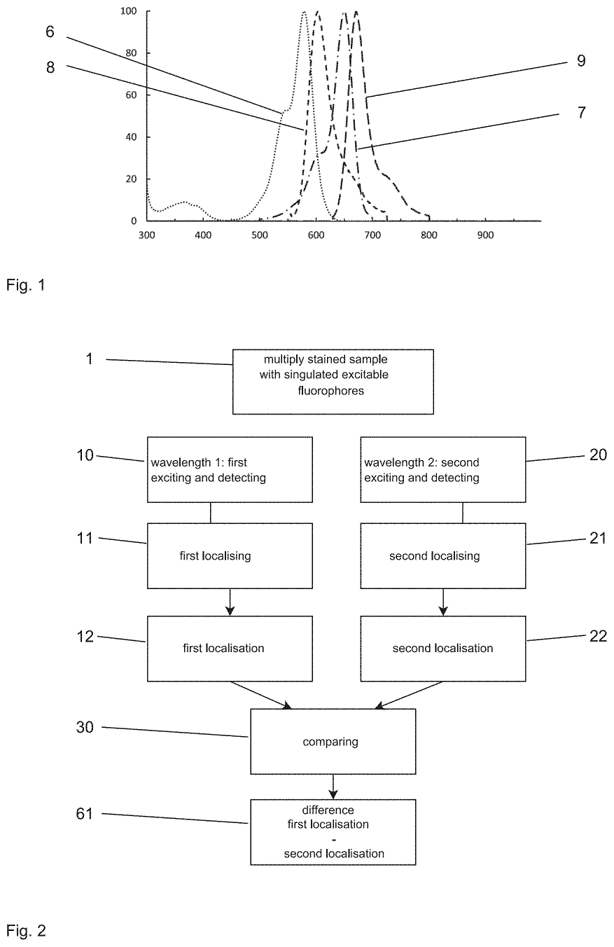

FIG. 1 shows a first excitation spectrum 6, a second excitation spectrum 7, a first emission spectrum 8, and a second excitation spectrum 9 of the two fluorescent dyes Alexa Fluor 568 and Alexa Fluor 647. This pair of dyes is suitable for carrying out procedures according to the present disclosure. All excitation spectra 6,7 and emission spectra 8,9 are normalised to their respective maximum value, the values at the ordinate are ratio values in percent of the corresponding to maximum value. The values at the abscissa indicate the wavelength in the unit nanometre. All of the following information on the excitation spectra 6,7 and emission spectra 8,9 are derived from the representation, i.e. not taken from a table of values. The reason for this is that it is not the exact values that are important, but only certain properties that are illustrated by the figure. The excitation spectrum 6 of the fluorescent dye Alexa Fluor 568 thus has a value of about 30% at a wavelength of 525 nm, it shows the maximum at a wavelength of 568 nm, at a wavelength of 600 nm the value of the excitation spectrum 6 is still just under 40%, at about 625 nm it is still about 5% and at a wavelength of 647 nm the value is close to zero (0). The excitation spectrum 7 of Alexa Fluor 647 has its maximum at 647 nm, at 625 nm its value is about 40%, at 600 nm about 30%, at a wavelength of 568 nm the value is about 10% and at a wavelength of 525 nm the value is less than 5%. It is decisive for the applicability of the dye pair that on the one hand the excitation spectra 6,7 show an overlap, i.e. that there are wavelengths with whose light both the one and the other dye can be excited, and that on the other hand there are wavelengths with whose light only one of the two dyes can be excited well at a time or with whose light one of the dyes can be excited much more strongly, for example ten times as strongly as the other. For the dye pair shown, for example, the dye Alexa Fluor 568 can be excited well with a wavelength of 525 nm, specifically with about 30% of the maximum achievable excitation probability for this dye, while the dye Alexa Fluor 647 can only be excited with less than 5% of the maximum achievable excitation probability. Similar favourable conditions result, for example, for the entire wavelength range from 525 nm to approximately at 568 nm. Conversely, at a wavelength of 625 nm, the dye Alexa Fluor 647 can be excited well, with a relative excitation probability of about 40%, and the dye Alexa Fluor 568 is hardly excited at this wavelength, with a relative excitation probability of about 5%.

FIG. 2 shows a flow chart of a first method according to the present disclosure. The method is carried out on a multiply stained sample with singulated excitable fluorophores or, more precisely, on a partial area 1 of a multiply stained sample with singulated excitable fluorophores, wherein the partial area 1 of the multiply stained sample can also comprise the entire sample. A singulated excitable fluorophore is a fluorophore which can be localised, the term localising 11,21,113 known from localisation microscopy denoting the process by which a localisation 12,22,114 of a fluorophore is obtained. It is known to the skilled person from the prior art how it can be ensured in a sample that singulated excitable fluorophores are present in the sample or in partial areas of the sample. In the left column, the following process steps or process elements are indicated from top to bottom: first exciting and detecting 10, first localising 11, first localisation 12. The first exciting and detecting 10 is performed using excitation light of a first wavelength. Correspondingly, further process steps or process elements are indicated in the right-hand column from top to bottom: second exciting and detecting 20, second localising 21 and second localisation 22. The second exciting and detecting 20 is carried out using excitation light of a second wavelength, which is different from the first wavelength. The steps of first exciting and detecting 10 and first localising 11 and second exciting and detecting 20 and second localising 21 are each connected by a line; the steps of first exciting and detecting 10 and first localising 11 are in fact in a close relationship, the nature of which depends on the specific execution or embodiment. In some embodiments, the first exciting and detecting 10 and the first localising 11 are performed simultaneously, that is, during the first exciting and detecting 10, the process of first localising 11 is performed, or the result of detecting 71 from the first exciting and detecting 10 is used directly for determining the first localisation 12. In other embodiments, the result of detecting 71 from the first exciting and detecting 10 is not used directly for determining the first localisation 12, or the localising 11 is not performed in direct connection with the first exciting and detecting 10, but the step of the first localising 11 is performed separately in connection with a further exciting and detecting 15. As a result of the first localising 11, a first localisation 12 is finally obtained. The above applies analogously to the steps or elements of second exciting and detecting 20, second localising 21 and second localisation 22. Generally, however, the second exciting and detecting 20 and the second localising 21 are carried out simultaneously, i.e. the process of second localising 21 is carried out during the second exciting and detecting 20, or the result of the detecting 71 from the second exciting and detecting 20 is used directly for the second localising 21. The steps of the left and right columns can be performed simultaneously. Then it is necessary that at least two spectral channels are used for detecting 71, at least one of which is set up in such a way that fluorescence from two of the dyes used can be detected in it, and in such a way that a localising 11,21,113 can be carried out for the two of the dyes used. They can be carried out one after the other in time, in which case a single spectral channel is sufficient for detecting 71. The first exciting and detecting 10 and the second exciting and detecting 20 can be carried out in the wide-field, as is usual for PALM or STORM, for example, or they can each be carried out in a small-field range, as in MINFLUX. The first and/or the second exciting and detecting 10,20 can also be carried out using a distribution of additional fluorescence prevention light, in particular in such a way that the localising is carried out by means of a STED localisation method or a MINSTED method.

It is known from the prior art to perform localisation microscopy procedures in the wide-field using two excitation wavelengths and two spectral channels. However, the combination of dyes, excitation wavelengths and spectral channels used for detecting is always selected in such a way that in each individual detection channel, which corresponds to an excitation wavelength, fluorescence of only one dye species is detected. This is to avoid that the localising of the fluorophores of one dye species is disturbed by fluorescence of another dye species. In the relevant prior art, however, this also excludes the possibility that a single singulated fluorophore is localised in a single one of the spectral channels once using light of one excitation wavelength and again using light of the other excitation wavelength. In contrast, according to the present disclosure, a single singulated fluorophore or a multitude of single singulated fluorophores is localised once using light of a first excitation wavelength, wavelength A 111, and a second time using light of a different excitation wavelength, wavelength B 112. The first localisation 12 of the left column is therefore a localisation 114 of the same fluorophore for which the second localisation 21 is also obtained. If the first exciting and detecting 10 and the second exciting and detecting 20 are performed in the wide-field, multiple first localisations 12 and multiple second localisations 22 can be obtained simultaneously.

After obtaining the first localisation 12 or the first localisations 12 and obtaining the second localisation 22 or the second localisations 22, the first localisation 12 or the first localisations 12 are compared with the second localisation 22 or the second localisations 22 so as to obtain, where appropriate in each case, a difference 31 between the first localisation 12 or the first localisations 12 and the second localisation 22 or the second localisations 22.

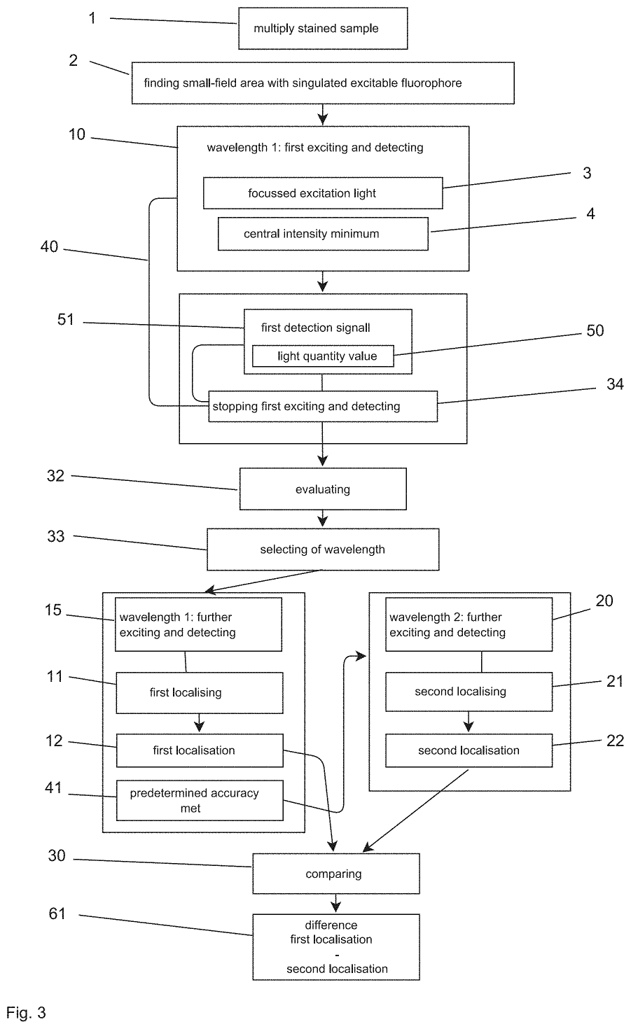

FIG. 3 shows a flow chart of an embodiment of the first method according to the present disclosure. In this embodiment, exciting and detecting 10,15,20 take place in a small-field area which is the partial area 1 of the multiply stained sample to be examined. The method starts with finding 2 the small-field area. This can be done by illuminating the sample or an area of the sample in wide-field, detecting fluorescence imaging the sample or the area of the sample in wide-field, and evaluating the image to identify a small-field area in which fluorescence originating from a singulated fluorophore is detected. However, this can also be done by scanning the sample or an area of the sample with focused excitation light 3 and detecting the fluorescent light emitted from the sample or the area of the sample. A small-field area with a singulated excitable fluorophore can then be identified on the basis of the amount of fluorescent light detected at an illumination location, for example on the basis of two limit values, wherein the detected amount of fluorescent light must exceed a lower limit value, which can be selected depending on a background signal, and must fall below an upper limit value. After the finding 2 of a small-field area or together with the finding 2 of a small-field area, a first exciting and detecting 10 takes place, wherein focused excitation light 3 of a first wavelength is used. In the embodiment shown, the focused excitation light 3 has a central intensity maximum 4. The exciting 70 of the first exciting and detecting 10 occurs within a small-field range. This means that the focal point of the excitation light is either not moved at all during the first exciting and detecting 10 or it is placed only within a range extending at most a few micrometres, for example with a diameter of 3 μm or only 2 μm. In the illustrated embodiment, the first exciting and detecting 10 takes place during a time span 40, after which a stopping 34 of the first exciting and detecting takes place. As a result of the first exciting and detecting 10, a first detection signal 51 is obtained, which comprises in particular a light quantity value 50, which is a measure of the amount of fluorescence detected during the time span 40.

Further, an evaluating 32 of the first detection signal 51 takes place. For example, its light quantity value 50 can be evaluated by comparing it with a reference value 27 not shown in this figure. For example, if a sample stained with Alexa Fluor 568 and Alexa Fluor 647 is excited with light of a wavelength of 640 nm during a first exciting and detecting 10, a comparatively large light quantity value 50 is obtained if the singulated excitable fluorophore is a fluorophore of the dye Alexa Fluor 568, while a comparatively low light quantity value 50 is obtained if the singulated excitable fluorophore is a fluorophore of the dye Alexa Fluor 647. In addition to the light quantity value 50, other characteristics of the first detection signal 51, if any are detected, such as a variation in the proportions of the total light quantity value 50 obtained in individual time spans of the time span 40 or values of proportions of the total light amount value 50 detected in different spectral detection channels, may also be evaluated. In the example shown, the evaluating 32 is used to perform selecting of a wavelength 33 such that further exciting and detecting 15 is subsequently performed using the first wavelength.

This further exciting and detecting 15 is performed to obtain a first localisation 12. Accordingly, together with the further exciting and detecting 15, a first localising 11 is performed. The first localising 11 may be performed using a MINFLUX method. In this case, the further exciting and detecting 15 is performed using focused excitation light 3 whose focus has a central intensity minimum 5. In addition to the focused excitation light 3 of the first wavelength, the small-field area can, even when a MINFLUX method is used, be irradiated with further focused light as fluorescence prevention light having an intensity distribution with a central intensity minimum, wherein the focal points of the two light distributions either coincide in each case or wherein the fluorescence prevention light is irradiated into the sample in any case in such a way that the focal point of the focused excitation light 3 is always placed in a region of the minimum of the fluorescence prevention light. Alternatively, the first localising 11 can be performed using a STED localisation method or a MINSTED method, in both cases using focused fluorescence prevention light having an intensity distribution with a central intensity minimum in addition to the excitation light of the first wavelength. This is particularly favourable if, of two dyes, the dye with the smaller wavelength of the maximum of the excitation spectrum has a large Stokes shift, so that both dyes can be excited essentially individually, but still with the same fluorescence prevention light. In the example shown, the first localising 11 is performed in conjunction with the further exciting and detecting 15 until a criterion 41 is met. In the specifically illustrated case, the criterion 41 is a predetermined accuracy of localisation. Other possible criteria 41 are, for example, a performed number of iterations of MINFLUX iterations or, when using MINSTED, an achieved intensity of the fluorescence prevention light. It is further possible in each case that additional information from the first detection signal 51 is used for obtaining the first localisation 12.

In cases where the singulated excitable fluorophore loses its excitability before the criterion 41 is met, the procedure cannot be fully performed on this singulated excitable fluorophore. Nevertheless, a first localisation 12 can be obtained, which can be used, for example, for image acquisition of the sample or a partial area of the sample.

Conversely, if the criterion 41 is met, the singulated excitable fluorophore is in an excitable state even after obtaining the first localisation 12. This is now utilised by performing a further exciting and detecting with a second wavelength, this further exciting and detecting being the second exciting and detecting 20 with which a second localisation 22 is obtained. For the second exciting and detecting 20 with the second localising 21, from which the second localisation 22 is obtained, the same applies mutatis mutandis with regard to the applicable methods as for the further exciting and detecting 15 with the first localising 11, from which the first localisation 12 is obtained.

After obtaining the first localisation 12 and obtaining the second localisation 22, the first localisation 12 is compared with the second localisation 22 so that a difference 31 of the first localisation 12 and the second localisation 22 is obtained.

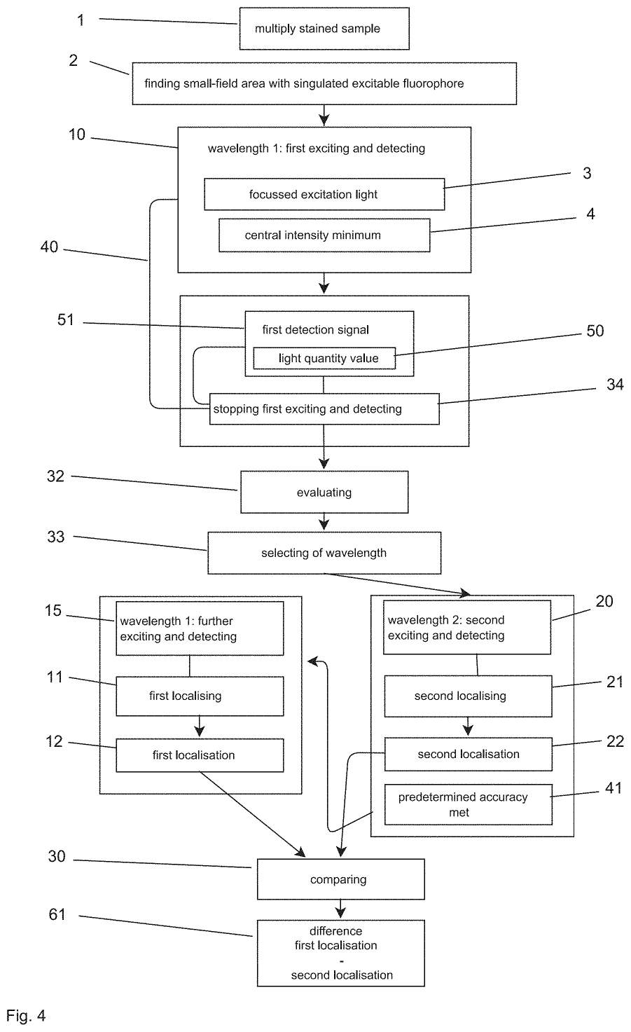

FIG. 4 shows a flow chart of another implementation of the same embodiment of the first method according to the present disclosure as in FIG. 3. The procedure differs because a fluorophore of a different dye species than that shown in FIG. 3 is present as a singulated excitable fluorophore in the small-field area under consideration. Therefore, during the selecting of a wavelength 33 based on the evaluating 32 of the first detection signal 51, a second wavelength is selected. In this case, after the selecting, the second exciting and detecting 20 is performed together with the second localising 21, so that a second localisation 22 is obtained. Here, these steps are performed until a criterion 41 is met, for example until a second localisation 22 is obtained with a predetermined accuracy. Subsequently, a further exciting and detecting 15 takes place together with the first localising 11, whereby a first localisation 12 is obtained.

After obtaining the second localisation 22 and obtaining the first localisation 12, which here occurs only after obtaining the second localisation 22, a comparing 30 of the first localisation 12 with the second localisation 22 is performed so that a difference 31 of the first localisation 12 and the second localisation 22 is obtained.

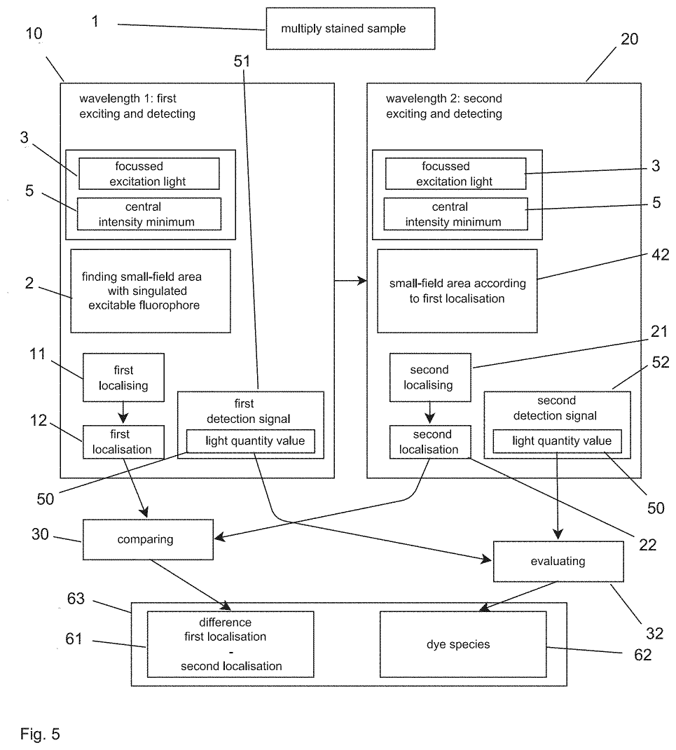

FIG. 5 shows a flow chart of another embodiment of the first method according to the present disclosure. In this embodiment, the finding of a small-field area 2 and the first localising 11, from which a first localisation 12 is obtained, are more closely linked. Both the finding of a small-field area 2 and the first localising 11 are performed with focused excitation light 3, in the example shown with a central intensity minimum 5. However, it is also possible that both the finding of a small-field area 2 and the first localising 11 are performed with focused excitation light 3 with a central intensity maximum. Before finding 2 a small-field area, a partial area 1 of a multiply stained sample is scanned with focused excitation light 3 until a fluorescence signal is obtained which originates from a singulated excitable fluorophore. The scanning can be done in a raster fashion, but it can also be done on spiral paths or on circular paths, each of which is displaced along a direction when a circle is completed. A region with an extent of a few micrometres around the location at which a fluorescence signal is obtained that originates from a singulated excitable fluorophore is the small-field area that is investigated with a method according to the present disclosure. For this purpose, the finding of the small-field area 2 is followed by a transition to the first exciting and detecting 10 with a first localising 11, from which a first localisation 12 is obtained. In addition, during the first exciting and detecting 10, a first detection signal 51 is obtained that comprises a light quantity value 50. For example, the first exciting and detecting 10 may be performed when the intensity distribution of the focused excitation light 3 is a donut distribution or a bottle beam distribution by positioning the focal point of the focused excitation light 3 of the first wavelength at a location within the small-field area, i.e. the partial area 1 of the multiply stained sample, wherein the detecting 71 comprises detecting the fluorescent light emitted from the singulated molecule, i.e. from the singulated fluorophore, as a result of the excitation with the focused excitation light of the first wavelength, wherein the fluorescent light is detected in a plane conjugate to the plane in which the focal point lies with a spatially resolving detector, or wherein a detection aperture is positioned within a plane oriented perpendicular to an optical axis at a plurality of positions around the optical axis. In both cases, detection occurs that is spatially resolved in the detection plane. From the local distribution of the fluorescence signal in the detection plane obtained in this way, a first localisation 12 can be obtained.

Subsequently, a second exciting and detecting 20 takes place within the same partial area 1 of the multiply stained sample, whereby a small-field area 42 can be determined according to the first localisation 12, which is smaller than the partial area 1 of the multiply stained sample. Together with the second exciting and detecting 20, a second localising 21 is performed, from which a second localisation 22 is obtained. In principle, this can be carried out in the same way as described in connection with FIGS. 3 and 4.

After obtaining the second localisation 22 and obtaining the first localisation 12, the first localisation 12 is compared with the second localisation 22 so that a difference 31 of the first localisation 12 and the second localisation 22 is obtained. In addition, an evaluating 32 of the first detection signal 51 and the second detection signal 52, in this case specifically of the respective light quantity values 50, is carried out. From the evaluating 32, information is obtained about the dye species 62 to which the singulated excitable fluorophore belongs, for which a first and a second localisation 12,22 have been obtained; generally, the dye species can be determined, since it is often known in advance which dye species have been used for dyeing the sample. The overall information 63 obtained from the method includes the difference 61 of the first localisation 12 and the second localisation 22 as well as the information about the dye species 62.

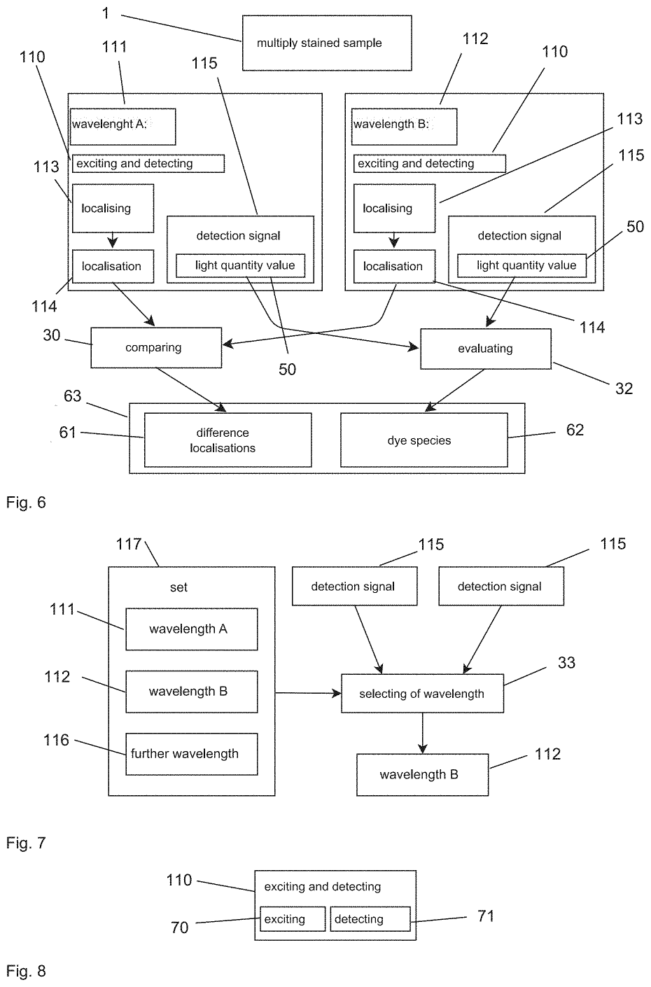

FIG. 6 is intended to illustrate an important aspect of the present disclosure. It shows a flowchart of steps that can be carried out in several of the embodiments of both methods according to the present disclosure. A key aspect of the present disclosure is that singulated excitable fluorophores of at least one species of the fluorophores with which partial areas 1 of the multiply stained sample are stained are localised once using excitation light of a first wavelength, in this figure the wavelength A 111, and once using excitation light of a second wavelength, in this figure the wavelength B 112, the wavelength A being different from the wavelength B. It may also be possible for fluorophores of both or all, if the sample is stained with more than two species of dye, that singulated excitable fluorophores are localised once using light of one wavelength A 111 and once using light of a wavelength B 112. In the left column it is schematically shown that with a wavelength A 111 an exciting and detecting 110 and a localising 113 with obtaining a localisation 114 takes place. In addition, a detection signal 115 comprising a light quantity value 50 is obtained. In the right column, the same is shown schematically for a wavelength B 112. The processes shown schematically in the two columns can be performed simultaneously, provided that the detections in the steps of of exciting and detecting 110 are performed in different spectral detection channels. If the steps of exciting and detecting 110 are each performed in a small-field, it may be advantageous to perform the steps of the left column (wavelength A 111) and the right column (wavelength B 112) in succession. For example, the steps can be carried out in such a way that the localising is carried out in each case according to a MINFLUX method, a MINSTED method or a STED localisation method. The steps of the right and left columns can also be performed alternately until the singulated excitable fluorophore has lost its excitability. In this way, either a localisation 114 determined from the set of individual localisations or a set with multiple localisations 114 can be obtained from the steps performed at each wavelength A 111. In addition, either a total detection signal 115 that results from the set of individual detection signals or a set of detection signals 115 is obtained. The same applies to the wavelength B 112. Subsequently, a comparing 30 of the two localisations 114 to the wavelengths A 111 and B 112 or the two sets with several localisations 114 is carried out, so that a difference of the localisations to the two wavelengths is determined. In addition, an evaluating of the two total detection signals 115 or the two sets of detection signals 115 is performed, whereby information is obtained about the dye species 62 of the singulated excitable fluorophore that was localised with light of the two wavelengths A 111 and B 112. The overall information 63 obtained from the method comprises the differences 61 of the localisations 114 as well as the information about the dye species 62 in each case.

FIG. 7 illustrates the selecting of a wavelength from a set of wavelengths. The set 117 comprises a wavelength A 111, a wavelength B 112 and a further wavelength 116, which are mutually different. The selecting 33 of a wavelength, in this case the wavelength B 112, is carried out here on the basis of two detection signals 115. The selecting 33 of a wavelength comprises here a step of the evaluating 32 shown separately in FIGS. 3 and 4, which is directed there to the evaluating of a first detection signal 51. By the arrow from the set 117 to the step of selecting 33 of a wavelength, it is intended to indicate that the elements from the set 117 can be made available for use by selecting 33 of the wavelength.

FIG. 8 illustrates the fact that each step of exciting and detecting 110 comprises the two elements of exciting 70 and detecting 71. A step of exciting and detecting 110 occurs in this application as first exciting and detecting 10, second exciting and detecting 20, further exciting and detecting 15, and generally as exciting and detecting 110. In each case, the exciting and detecting 10,15,20,110 comprises corresponding elements of exciting 70 and detecting.

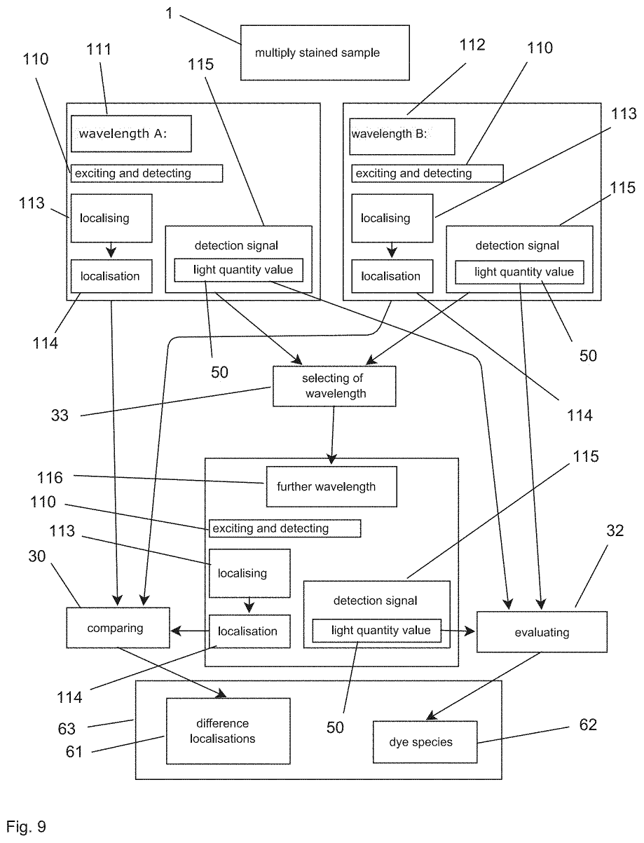

FIG. 9 is intended to illustrate an important aspect of the present disclosure. It shows a flow chart of steps that can be carried out in multiple of the embodiments of both methods according to the present disclosure. The upper part represents the steps exciting and detecting 110 already shown in FIG. 6, once for a wavelength A 111 and once for a wavelength B 112, in each case with the associated step localising 113 and the associated elements localisation 114 and detection signal 115, which in each case comprises a light quantity value 50. The further steps comparing 30 and evaluating 32 shown in FIG. 6 as well as the elements difference 61 of the localisations and information about the dye species 62 of the singulated excitable fluorophore are also included in FIG. 9, but here additionally linked with a step exciting and detecting 110, which is carried out with a further wavelength 116. For all steps known from FIG. 6, the explanations given in their description also apply. The further wavelength 116 shown in this FIG. 9 can be identical with one of the wavelengths A 111 and B 112, but it can also be different from both. The addition to the processes shown in FIG. 6 is that at a time when at least one localisation 114 and at least one detection signal 115 have been obtained for both wavelength A 111 and wavelength B 112, a selecting 33 of a further wavelength 116 for further exciting and detecting 110 takes place. The selecting 33 also includes an evaluating 32 shown separately elsewhere. The selecting of one of the wavelengths A 111 or B 112 as a further wavelength 116 can take place, for example, if at least one localisation 114 is to be obtained for each of the wavelengths A 111 and B 112 for a single excitable fluorophore in each case and if, in addition, the most accurate possible localisation 114 is to be obtained overall, in addition possibly with the aim of stressing the sample as little as possible. In this case, the two corresponding localisings 113 are carried out first, so that at least one localisation 114 is obtained for each of the wavelengths A 111 and B 112.

When selecting 33, a further wavelength 116 can now be selected which excites the singulated excitable fluorophore as efficiently as possible. In this way, the singulated excitable fluorophore can be well localised with the lowest possible overall stress on the sample. If only two wavelengths are available for selection, the wavelength of the two wavelengths A 111 or B 112 for which the larger light quantity value 50 or a larger value derived from the light quantity value 50 taking into account the irradiated light quantity, which is known, for example, as part of the detection signal 115, was obtained during the associated exciting and detecting 115 can be selected, for example.

Another possibility, in particular if a wavelength different from the wavelengths A 111 and B 112 is available, is to infer from a ratio of the light quantity values 50 or corresponding values derived therefrom the species of dye to which the singulated excitable fluorophore belongs and accordingly to select the wavelength from the set 117 of wavelengths with which the dye species in question is best excitable. For example, such a comparison, when performed on a sample stained with at least the dyes Alexa Fluor 568 and Alexa Fluor 647 and examined with a wavelength A 111 of 525 nm and a wavelength B of 625 nm, may reveal that the singuated excitable fluorophore that was located belongs to the dye species Alexa Fluor 647. Then, if a wavelength of 647 nm is selectable as a further wavelength 116, this wavelength, at which the first excitation spectrum 7, which is the excitation spectrum of the Alexa Fluor 647 dye species, can be selected for the following exciting and detecting 110. At this wavelength, not only is the excitability of the Alexa Fluor 647 dye at a maximum, but also the excitability of the Alexa Fluor 568 dye is barely present, so that during exciting 70 with the further wavelength 116 of 647 nm, hardly any background fluorescence of the Alexa Fluor 568 dye is excited.

Subsequently, a comparing 30 of the localisations 114 is carried out, so that differences 61 of the localisations 114 are obtained, and an evaluating 32 of the detection signals 115, in the figure specifically shown the light quantity values 50, in order to obtain information about the dye species 62 or to confirm this. If the selecting 33 of a further wavelength has already included an evaluating 32 with respect to the dye species, then the last evaluating 32 can also be omitted, in which case the information about the dye species 62 from the first evaluating 32, which is not shown, must be adopted for the overall information 63. The overall information 63 obtained from the procedure then comprises the differences 61 of the localisations 114 as well as the information about the dye species 62.

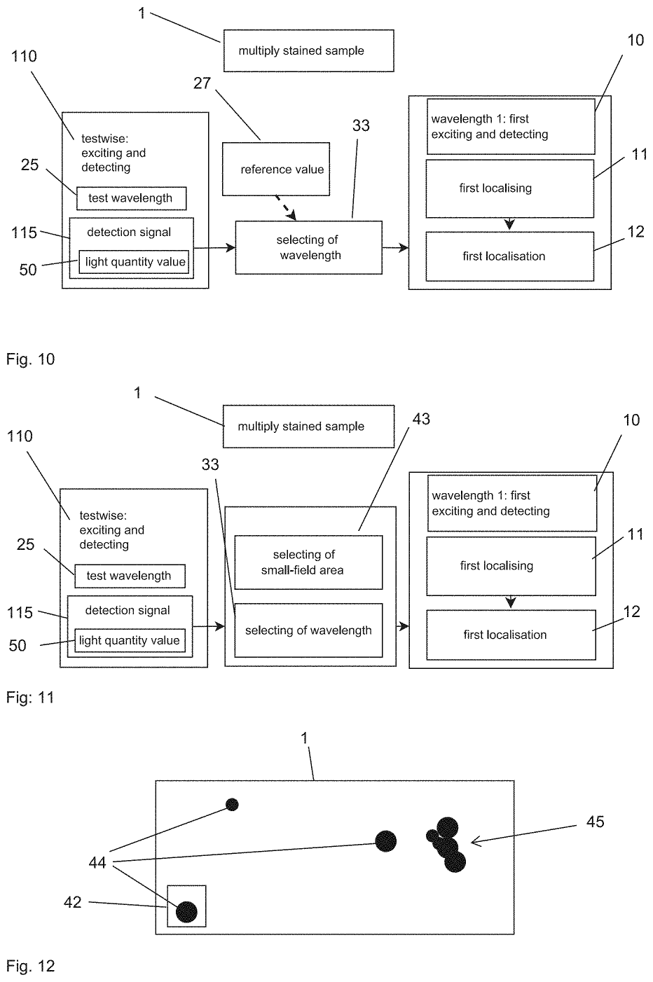

FIG. 10 shows a flow chart of a first embodiment of a second method according to the present disclosure. Also this method is carried out on a multiply stained sample with singulated excitable fluorophores or, more precisely, on a partial area 1 of a multiply stained sample with singulated to excitable fluorophores, whereby the partial area 1 of the multiply stained sample can also comprise the entire sample. In this method, a first step is exciting and detecting 110, which is carried out testwise with a test wavelength 25. During testwise exciting and detecting 110, a detection signal 115 comprising a light quantity value 50 is obtained. Based on the detection signal 115, in this first embodiment of the second method according to the present disclosure, a selecting 33 of a first wavelength is performed, which is used for a first localising 11. Whereas in the first method, in the first step performed of exciting and detecting 110, it is mandatory to use a wavelength with which a first localising 11 is performed, this is possible here, but not necessary. After selecting 33 of a first wavelength, a first exciting and detecting 10 is then performed with a first localising 11, from which a first localisation 12 is obtained. Several possibilities are available for selecting 33 of the first wavelength. A reference value 27 is shown in the figure. The dashing of the arrow to the step of selecting 33 of the first wavelength is intended to indicate that the use of a reference value 27 is only one of the possibilities. In particular, it is a good possibility when the partial area 1 of the multiply stained sample is a small-field area. How such a small-field area with a singulated excitable fluorophore can be found is known, amongst others, from the prior art. If the partial region 1 of the multiply stained sample is a wide-field area and if this is to be investigated further by means of methods carried out in the wide-field, it can be determined, for example, on the basis of the detection signal 115, whether and how many singulated excitable fluorophores show in the image field fluorescence emission as well as, if applicable, how many show weak and how many show strong fluorescence emission. Based on this analysis, a wavelength can then be selected with which the largest possible number of singulated fluorophores can be localised simultaneously at the relevant recording time.

With reference to FIG. 11, a course of a further embodiment of the second method according to the present disclosure shall be explained. Also, in this embodiment of the second method according to the present disclosure exciting and detecting 110 is carried out in a first step, which is performed testwise with a test wavelength 25. During testwise exciting and detecting 110, a detection signal 115 is obtained that comprises a light quantity value 50. In principle, the testwise exciting and detecting 11 can be performed in a multitude of sub-regions of the sample which are small-field areas. Preferably, however, the testwise exciting and detecting 11 in this embodiment takes place in the wide-field. On the basis of the detection signal 115, in this further embodiment of the second method according to the present disclosure, a selection 43 of a small-field area 42 (not shown in this figure) in which a first localisation 11 is to take place takes place. Subsequently, as in the first embodiment of this method, a first exciting and detecting 10 is carried out with a first localisation 11, as a result of which a first localisation 12 is obtained. Optionally, before the first exciting and detecting 10, in addition to the selection 43 of a small-field area 42, a selection 33 of a wavelength is performed. In principle, both selections 33,43 can be carried out in parallel or dependent on each other.

FIG. 12 shows a partial region 1 of a multiply stained sample with a small-field area 42 with an singulated excitable fluorophore 44 and further excitable fluorophores 44,45.

One possibility of selecting 43 of a small-field area 44 shown in FIG. 11 can now be explained with reference to FIGS. 11 and 12. A wide-field image of a partial area 1 of a multiply stained sample is taken. In this image, fluorophores 44,45 from the partial area 1 of the multiply stained sample can be imaged. The image corresponds to the sample except for measurement uncertainties and imaging errors. The measurement uncertainties can be large because the testwise exciting and detecting 110 with the test wavelength 25 does not serve to obtain an exact localisation, but serves here only to find a small-field area 42, during the examination of which an exact localisation is to be obtained. As a small-field area 42 to be examined, only such an area can be selected on the basis of the illustration in which a singulated excitable fluorophore 42 is present. In the partial area 1 of the multiply stained sample, three singulated excitable fluorophores 42 are present, two of which emit strongly, as indicated by the larger radius, and one of which emits more weakly, as indicated by the smaller radius. To the right of the partial area, multiple fluorophores 45, weaker emitting and stronger emitting, are present but which are not singulated. A small-field area 42 can now be selected by examining the image of partial area 1 of the multiply stained sample. On the basis of the image not shown, a small-field area 42 can now be defined around the location of the image of the strongly emitting fluorophore 42, which has the greater distance to the non-singulated excitable fluorophores 45. This small-field area 42 is slightly shifted with respect to the actual location of the singulated excitable fluorophore 42 because of measurement uncertainty. After selecting, the test wavelength can be used as the first wavelength. Provided that the selecting 43 of the small-field area 42 is done in such a way that the test wavelength can be used as the first wavelength, there is no step of selecting 33 of a wavelength at this point.

Another possibility is that an area around the location of the only singulated excitable fluorophore 44 that shows weaker emission would be selected as the small-field area 42 because examination of the image indicates that particularly good localisation of this fluorophore is possible using a wavelength other than the test wavelength for the first localising 10. In this case, therefore, both a selecting 43 of a small-field area 42 and a selecting 33 of a wavelength for the first exciting and detecting 10 would take place for the following first exciting and detecting 10.

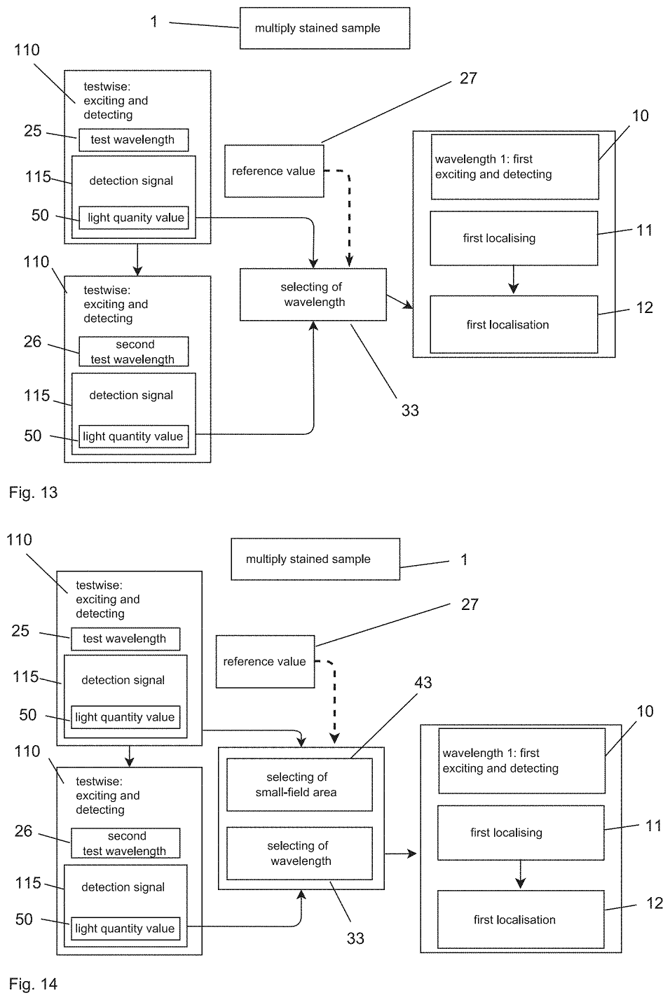

FIG. 13 shows a flow chart of a further embodiment of the second method according to the present disclosure. The diagram contains all the elements shown in FIG. 10. For a description of the relationships associated with these elements, it is referred to the information on FIG. 10. In addition, FIG. 13 shows a further testwise exciting and detecting 110, which is performed with a second test wavelength 26, which is different from the first test wavelength 25. This further testwise exciting and detecting 110 may, if the detection 71 is performed in multiple different spectral detection channels, be performed simultaneously and may generally be performed after the testwise exciting and detecting 110 with the first test wavelength 25. A detection signal 115 comprising a light quantity value 50 is also obtained for the further testwise exciting and detecting 110 with the second test wavelength 26. In the embodiment shown in this figure, the selecting 33 of a first wavelength used for a first localising 11 is performed on the basis of the two detection signals 115 obtained at the first test wavelength 25 and the second test wavelength 26, respectively. For example, a ratio of the two light quantity values may be characteristic of a dye species of a singulated excitable fluorophore, for whose first exciting and detecting 10 including the associated first localising 11 the most suitable wavelength is then selected. When the testwise exciting and detecting 110 is performed in the wide-field, the images of the partial area 1 of the multiply stained sample can be examined, for example, to determine when using which of the test wavelengths 25,26 more singulated excitable fluorophors that emit strongly are contained. This test wavelength 25,26 can then be selected as the wavelength for the first exciting and detecting 10. In addition to the two detection signals 115, a reference value 27 may also be used for selecting 33 of a wavelength. The reference value 27, which need not be a scalar value, may include, for example, entries for comparison light quantity values or entries for comparison ratios of light quantity values with which the two light quantity values 50 or their ratio are compared to select a wavelength for the first exciting and detecting 10.

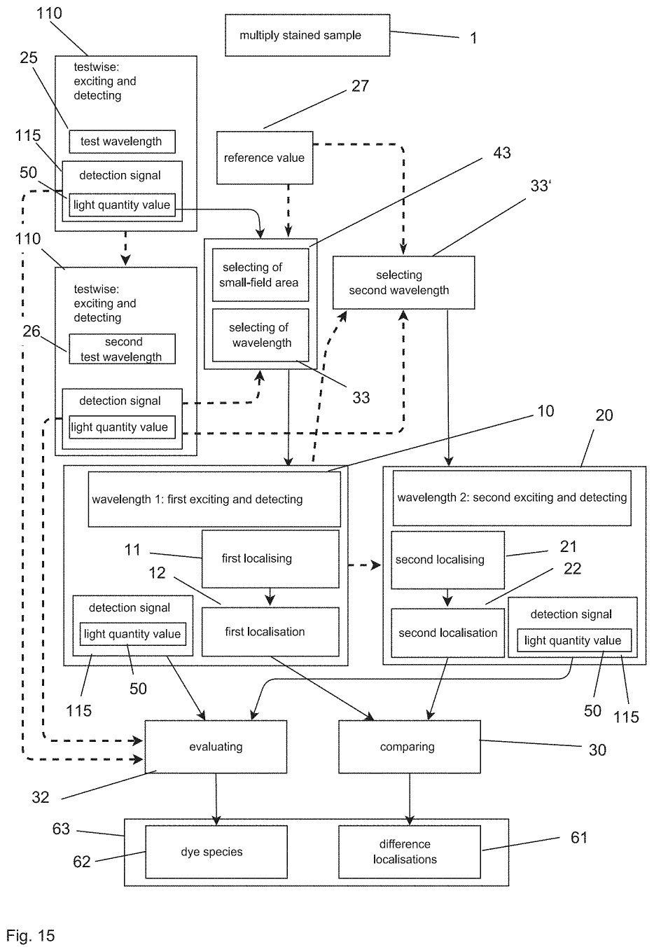

In FIG. 14, an embodiment is shown in which both the step of a further testwise exciting and detecting 110 with a second test wavelength 26 and that of selecting 43 of a small-field area 42 are included. In this embodiment, the selecting 43 of a small-field area 42 (not shown in this figure) in which a first localising 11 is to be performed can be performed on the basis of the two detection signals 115 obtained once using the first test wavelength 25 and once using the second test wavelength 26. Subsequently, a first exciting and detecting 10 is performed with a first localising 11, as a result of which a first localisation 12 is obtained. Optionally, prior to the first exciting and detecting 10, in addition to the selecting 43 of a small-field area 42, a selecting 33 of a wavelength is performed. In principle, both selecting 33,43 may be performed in parallel or in dependence on each other, substantially in accordance with the indications given in connection with FIG. 11 and in connection with FIGS. 11 and 12.

In FIG. 15, an embodiment is shown in which a difference between the first localisation 12 and the second localisation 22 of a singulated excitable fluorophore is finally obtained by comparing 30 a first localisation 12 and a second localisation 22. In the upper part of the figure, there are elements known from FIG. 14. The group of FIG. 14 with the elements first exciting and detecting 10, first localising 11 and first localisation 12 is found in FIG. 15 supplemented by the element detection signal 115, which comprises an element light quantity value 50, shifted downwards in the left part of the figure, but is otherwise linked essentially in the same way with the group of elements selecting of a small-field area 43 and selecting of a wavelength 33 as in FIG. 14. In FIG. 15, such links are shown in dashed lines which correspond to optional steps or links in the course of the method. Compared to FIG. 14, a step of selecting of a second wavelength 33′ is added in the upper part.

For the description of the elements also contained in FIG. 14 and the process steps, links and elements shown therein, reference is first made to the description of FIG. 14. In the embodiments illustrated in FIG. 15, the selecting of a second wavelength 33′ and a second exciting and detecting 20 with a second localising 21, from which a second localisation 22 is obtained, are now added. In addition, in addition to both the first localisation 12 and the second localisation 22, a detection signal 115 is obtained in each case, which comprises a light quantity value 50 in each case. If the lower part is now compared with the elements first exciting and detecting 10 and second exciting and detecting 20 as well as all the elements entered below, it can be seen that this part corresponds to FIG. 6 with the difference that in FIG. 6 reference is made generally to specific elements such as wavelengths A 111 and B 112, a localising 113 and so on, whereas in FIG. 15 reference is made to specific elements such as, for example, the first localising 11 and the second localisation 22 and so on. For the linking of the elements and the respective procedures, reference is therefore first made here to the description of FIG. 6. FIG. 15 shows an optional link between the left-hand element block with the first exciting and detecting 10 and the corresponding right-hand block. Although this is not entered in FIG. 6, the description indicates that the right-hand block should be executed after the left-hand block under certain conditions.

The steps after selecting 33 of the wavelength for the first detecting 10 or selecting 43 of a small-field area 42 thus correspond to steps that are also known from the first method. When selecting 33′ of a second wavelength for the second exciting and detecting 20, a wavelength is selected that is different from the wavelength for the first exciting and detecting 20. This wavelength may be selected in such a way that it is particularly suitable for localising a different species of fluorophore than the one to which the fluorophore to be localised in this step belongs. At the same time, it must be chosen in such a way that localising of the fluorophore to be localised in this step is possible. How this is to be understood becomes clear from FIG. 1 with the associated description. Overall, this achieves that two localisations 114 are obtained for the singulated excitable fluorophore, one of which can be highly accurate and another of which can have a lower accuracy, or higher uncertainty.

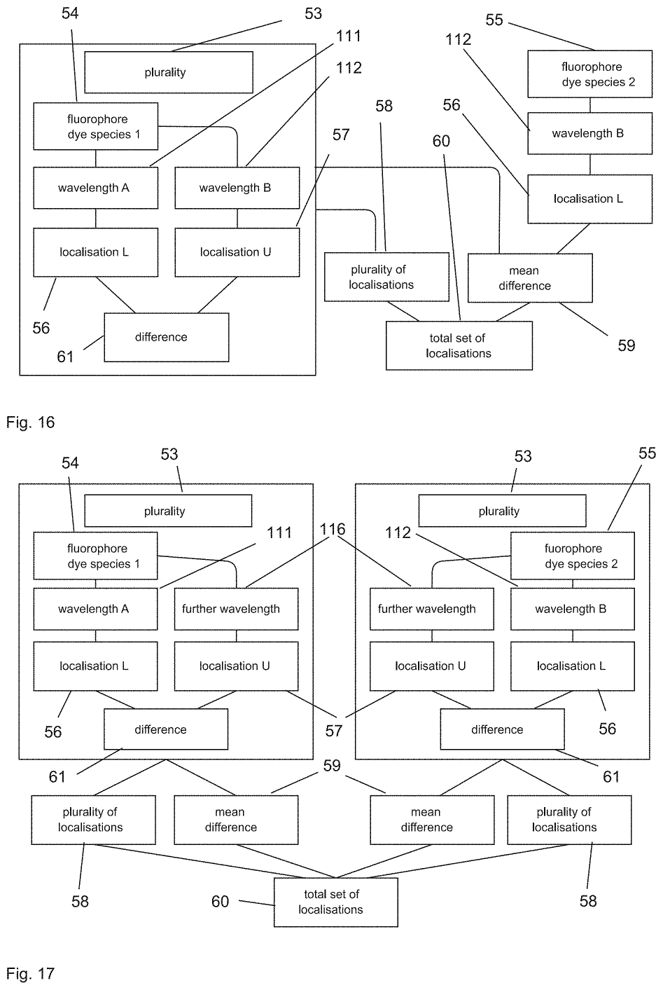

With reference to FIG. 16, a possibility for co-localisation of fluorophores of multiple, specifically two, fluorescent dyes in a common reference system is shown. A plurality 53 of fluorophores of a first dye 54 is localised by means of any one of the methods according to the present disclosure, whereby for each single fluorophore one or more localisations L 56 are obtained at a wavelength A 111 and one or more localisations U 57 are obtained at a wavelength B 112. The wavelength A 111 is a wavelength that is well suited for localising 113 singulated excitable fluorophores of the first dye 54. The wavelength A 111 can be the first wavelength, i.e. each individual localisation L 56 can be a first localisation 12, or it can be the second wavelength, i.e. each individual localisation L 56 can be a second localisation 22. The wavelength B 111 may be a wavelength that is less suitable for localising 113 isolated excitable fluorophores of the first dye 54, but at the same time is well suited for localising 113 singulated excitable fluorophores of the second dye 55. This, the wavelength B 112, can also be the first wavelength or the second wavelength, depending on the method and the specific process sequence, i.e. each individual localisation U 57 can be a first localisation 12 or a second localisation 22. In total, a plurality of localisations 58 is obtained. This plurality may be the set of localisations L 56 or a subset or a set derived from the set of localisations L 56. For example, it is possible that a plurality of localisations L 56 are identified as localisations of the same singulated fluorophore at different points in time and, combined into a single localisation of that fluorophore, are included in the plurality of localisations 58. A difference 61 is determined for each of the localisations L 56 and U 57. A mean difference 59 between the localisations is determined from the set of differences 61. Depending on the number of individual differences 61, this mean difference 59 can be determined with higher accuracy, i.e. less uncertainty, than a single difference 61. Therefore, it can be accepted that the individual uncertainties of the localisations U 57, which are included in the uncertainties of the differences 61, are greater than those of the localisations L 57, as generally results from the different suitability of the wavelengths A 111 and B112 for localising the first dye 54. The majority of the localisations L 56 and U 57 may be results of localising 113 within a spatially restricted area of a sample, or results of localising 113 within a restricted time span. The latter is advantageous when the sample or the characteristics of the microscope used to examine the sample are subject to variations over time.

A singulated excitable fluorophore of a second dye 55 is localised with a wavelength B 112 which is well suited for this purpose. A localisation L 56 is obtained. The mean difference 59 resulting from the different wavelengths A 111 and B 112 during localising is known from the localisations of the first dye 54. The localisation L 56 of this singulated fluorophore of the second dye 55 corrected by this mean difference 59 is now registered together with the multitude of the localisations 58 into a total set of localisations 60, whereby a co-localisation of fluorophores of different dyes is achieved. Preferably, the localisation L 56 of the fluorophore of the second dye 55 and the mean difference 59 are determined from data collected within a spatial or temporal neighbourhood, preferably within a spatial and temporal neighbourhood.

It is directly clear that in the same way localisations L 56 to multiple or many fluorophores of the second dye 55 can be co-localised with fluorophores of the first dye 54. Similarly, it is directly clear that fluorophores of the first dye 54 to which only localisations L 56 were obtained using wavelength 111 but no localisations U 57 were obtained using wavelength B 112 can also be co-localised in the same way. Thus, in order to obtain an image of a multiply stained sample or of a partial area 1 of a multiply stained sample in which fluorophores of multiple, for example two, dyes are co-localised, in particular co-localised with high accuracy, it is sufficient to localise only a subset of the fluorophores used for image acquisition using two wavelengths.

With reference to FIG. 17 another possibility for co-localisation of fluorophores of multiple, specifically two, fluorescent dyes in a common reference system is illustrated. In this embodiment, it is not necessary to obtain localisations U 57 for fluorophores of one of the dyes with a wavelength that is a particularly suitable wavelength for localising fluorophores of the other dye in order to determine a difference 61 of localisations of different wavelengths. Rather, a common further wavelength 116 is used for fluorophores of both dyes 54,55 to obtain respective associated localisations U 57. Localisations L 56 are obtained here for a plurality 53 of fluorophores of the first dye 54 with a wavelength A 111 and for a plurality 53 of fluorophores of the second dye 55 with a wavelength B 112. In this way, pluralities 58 of localisations 59 and a mean difference 59 are obtained for both dyes. This mean difference 59 relates in each case to a further wavelength 116 common to both species of dye. Accordingly, the plurality 58 of localisations L 56 of the singulated fluorophores of the second dye 55, taking into account both mean differences 59, is classified together with the plurality 58 of localisations L 56 of the singulated fluorophores of the first dye 54 into a total set of localisations 60, whereby co-localisation of fluorophores of different dyes is achieved. In accordance with the explanations for FIG. 16, it is also true here, and specifically for each of the two dyes, that localisations U 57 do not have to be obtained for all the singulated fluorophores used for imaging on a multiply stained sample. Rather, it is sufficient, for example, to obtain them for such a quantity of singulated fluorophores that the mean difference 59 is obtained in each case with a desired accuracy.

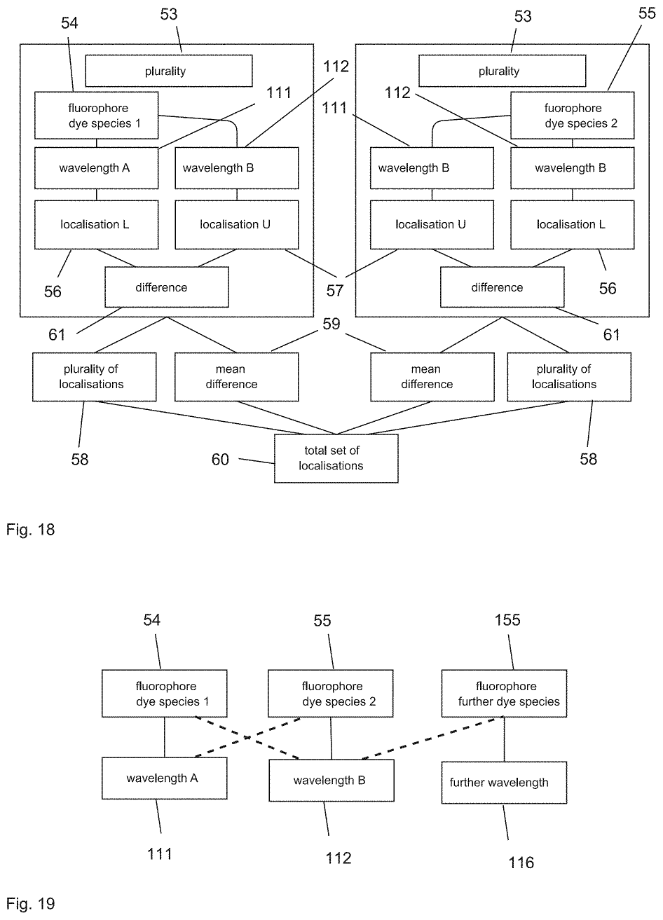

With reference to FIG. 18 another possibility for co-localisation of fluorophores of multiple, specifically two, fluorescent dyes in a common reference system is illustrated. In this embodiment, both fluorophores of a first dye 54 and fluorophores of a second dye 55 are each localised with light of a wavelength A 111 and with light of a wavelength B 112, whereby localisations L 56 are obtained for fluorophores of the first dye 54 with the wavelength A 111 and localisations U 57 are obtained with the wavelength B 112. Conversely, for fluorophores of the second dye 55, localisations L 56 are obtained with wavelength B 112 and localisations U 57 are obtained with wavelength A 112. This means that the wavelengths A 111 and B 112 are selected in such a way that they excite one of the dyes well and the other sufficiently, the roles of the wavelengths depending on the particular dye under consideration. The respective pluralities 58 of the localisations L to both dyes are now combined, taking into account the two mean differences 59, from which, for example, a sign-correct mean value can be formed, to form a total set of localisations 60 in which singulated fluorophores of both dyes are co-localised. Again, as explicated with reference to the previous figures, it is not necessary to obtain localisations U 57 for all singulated fluorophores used for imaging on a multiply stained sample.

Fluorophores of more than two dye species can also be co-localised. This can be done, for example, according to a sequence shown in FIG. 18. As shown, for example, in FIG. 9, detection signals 115, each comprising a light quantity value 50, may be present for the respective localisations 114. It is therefore possible that, for example, dye molecules of two dye species with a common wavelength can be well localised and distinguished on the basis of the light quantity values 50. For this purpose, it is advantageous to record light quantity values 50 for both dye species for all singulated excitable fluorophores also with a second wavelength of excitation light, for example by also obtaining localisations U 57 for all singulated excitable fluorophores. A further possibility results from a synopsis of, for example, FIGS. 16 and 17.

Another possibility to obtain co-localisations for fluorophores of more than two dye species using a method according to the present disclosure is explained here with reference to FIG. 19. As explained above, for co-localisation it is sufficient that for one of two dye species localisations are performed using two wavelengths for the excitation light, if fluorophores of the second dye are localised with excitation light of one of the two wavelengths. Referring now to FIG. 19, the relationships of fluorophores of a first dye 54, fluorophores of a second dye 55 and fluorophores of a further dye 155 to a wavelength A 111, a wavelength B 112 and a further wavelength 116 are shown. It is expressed by the solid lines that the wavelength A 111 is well suited for localising fluorophores of a first dye 54, the wavelength B 112 is well suited for localising fluorophores of a second dye 55 and the further wavelength 116 is well suited for localising fluorophores of a further dye 155. In addition, wavelength A 111 is sufficiently suitable for localising fluorophores of the second dye 55 and wavelength B 112 is sufficiently suitable for localising fluorophores of the first dye 54 to detect differences 61 in localisations with the different wavelengths; this is expressed by the dashed connection. The wavelength B 112 is sufficiently suitable for localising fluorophores of the further dye 155 in order to detect differences 61 of the localisations with the different wavelengths, in this case the wavelength B 112 and the further wavelength 116. The respective determination of the differences 61 of the localisations makes it possible to combine all localisations in a total set of localisations 60. Here, too, information about the species of dye can be available for each localisation of the total set of localisations 60, which in each case can be obtained from the detection signals 115 with the light quantity values 50, as explained in the corresponding context.

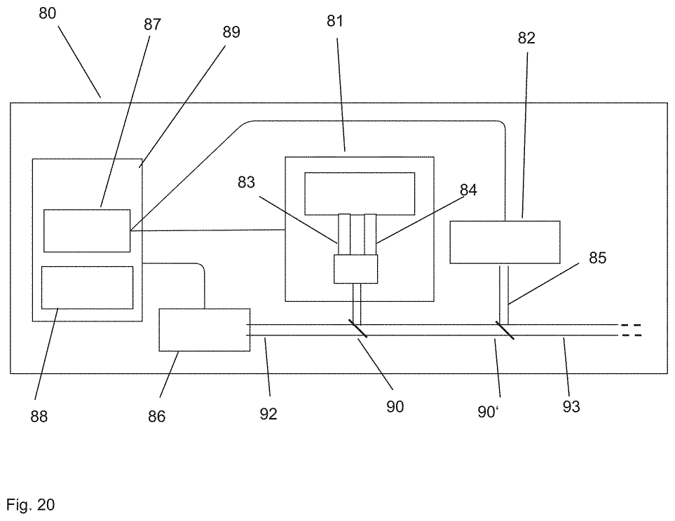

FIG. 20 schematically shows a microscope 80 according to the present disclosure. In the embodiment shown, it has a control unit 89 in which a selection unit 87, which is set up to select a wavelength for excitation on the basis of a detection signal 51, 52, 115 with regard to a fluorescence emission of a single fluorophore, and a calculation unit 89, which is set up to determine a localisation and a difference in localisations from two detection signals 51, 52, 115 with regard to a fluorescence emission of a single fluorophore, are integrated. That a wavelength is selected on the basis of a detection signal 51,52,115 comprises that further information such as a reference value 27 or a further detection signal 115 is also evaluated during the selecting 33. The selection unit 87 is linked via control lines to a laser unit 81, which is arranged to emit narrowband light of two wavelengths, and a laser unit 82, which is arranged to emit narrowband light of a third wavelength, which is different from the two wavelengths of the first laser unit 81. Further, the microscope 80 comprises a detection unit 86 which can detect fluorescent light emitted from a sample. The detection unit 86 is connected to the selection unit 87 by means of the control unit 89. The narrow-band light 83,84,85 is coupled via beam couplers 90,90′ into a beam path 93 through which the light can be directed onto or into a sample. The basic construction of various microscopes is known to the skilled person. The illustration of further components, for example of the beam path 93, is therefore omitted here. Via the beam path 93, fluorescent light 92 emitted from a sample can be directed to the detection unit 86. Furthermore, the microscope 1 has a calculation unit 88 which is set up to determine a localisation 12,22 and a difference 61 of the localisations from two detection signals 51,52,115 with respect to a fluorescence emission of a single fluorophore. The wavelengths of the narrowband lights 83,84,85 comprise two wavelengths that differ from each other by a value between 200 nm and 50 nm, for example, the narrowband light 85 may be light of a wavelength of 488 nm or 525 nm and the narrowband light 83 may be light of a wavelength of about 525 nm and the narrowband light 84 may be, for example, light of a wavelength of about 650 nm. Narrow-band light here means light with spectral widths in the range of up to a few nanometres. If the narrowband light 83,84,85 is intended to excite fluorophores by two-photon absorption or more generally multiphoton absorption, the bandwidth of the narrowband light 83,84,85 may be up to 50 nm. If the narrowband light 83,84,85 is intended to excite fluorophores by single-photon absorption, it typically has bandwidths in the range below 20 nm, preferably below 15 nm or below 10 nm.

### LIST OF REFERENCE SIGNS

1 partial area
2 finding a small-field area
3 focused excitation light
4 central intensity maximum
5 central intensity minimum
6 first excitation spectrum
7 second excitation spectrum
8 first emission spectrum
9 second emission spectrum
10 first exciting and detecting
11 first localising
12 first localisation
13 first wavelength
15 further exciting and detecting
20 second exciting and detecting
21 second localising
22 second localisation
23 second wavelength
25 test wavelength
26 second test wavelength
27 reference value
30 comparing
32 evaluating
33 selecting of a wavelength
33′ selecting of a second wavelength
34 stopping of exciting and detecting
40 time span
41 criterion
42 small-field area
43 selecting of a small-field area
44 singulated excitable fluorophore
45 excitable fluorophores
50 light quantity value
51 first detection signal
52 second detection signal
53 plurality
54 fluorophore of a first dye
55 fluorophore of a second dye
56 localisation L
57 localisation U
58 plurality of localisations
59 mean difference
60 total set of localisations
61 difference
62 information about dye species
63 overall information
70 exciting
71 detecting
80 microscope
81 laser unit
82 laser unit
83 narrowband light
84 narrowband light
85 narrowband light
86 detection unit
87 selection unit
88 calculation unit
89 control unit
90,90′ beam coupler
92 fluorescent light
93 beam path
110 exciting and detecting
111 wavelength A
112 wavelength B
113 localising
114 localisation
115 detection signal
116 further wavelength
117 set
155 fluorophore of further dye

What is claimed is:

1. A localisation microscopic method for examining a sample stained with multiple dyes comprising the method steps of
a first exciting and detecting, wherein a partial area of the sample is exposed to excitation light of a first wavelength and wherein fluorescent light emitted from the partial area of the sample as a result of the excitation with the excitation light of the first wavelength by a singulated fluorophore of a dye is detected and a first detection signal is obtained,
a first localising of the singulated fluorophore and obtaining a first localisation,
a second exciting and detecting, wherein the partial area of the sample is exposed to excitation light of a second wavelength and wherein fluorescent light emitted from the partial area of the sample as a result of the excitation with the excitation light of the second wavelength by the singulated fluorophore of the dye is detected and a second detection signal is obtained,
a second localising of the singulated fluorophore and obtaining a second localisation,
determining a difference between the first localisation and the second localisation.

2. The method according to claim 1, wherein the partial area of the sample is a small-field area and that the excitation light of the first wavelength and the excitation light of the second wavelength is focused light having a focal point and having an intensity distribution.

3. The method according to claim 2, wherein the intensity distribution of the focused light of the first wavelength has a central minimum and wherein the step of the first exciting is performed by positioning the focal point of the excitation light of the first wavelength at a location within the partial area, wherein the step of detecting comprises detecting the fluorescent light emitted from the singulated fluorophore as a result of the excitation with the excitation light of the first wavelength, wherein the fluorescent light is detected in a plane conjugate to the plane in which the focal point is located with a spatially resolved detector or that a detection aperture is positioned within a plane oriented perpendicular to an optical axis at a plurality of positions around the optical axis.

4. The method according to claim 2, wherein the intensity distribution of the focused light of the first wavelength has a central maximum and in that the first exciting and detecting, wherein a partial area of the sample is exposed to excitation light of the first wavelength, is performed by positioning the focal point of the excitation light of the first wavelength at a sequence of locations within the partial area.

5. The method according to claim 2, wherein the intensity distribution of the focused light of the second wavelength has a central minimum and wherein the second excitation is performed by positioning the focal point of the excitation light of the second wavelength at a sequence of nominal locations enclosing the first location, the enclosed area having a first extent, within the partial area.

6. The method according to claim 2, wherein it comprises the method steps of
selecting of a wavelength from a predetermined set of at least two wavelengths for further exciting of the partial area of the sample based on the first detection signal and/or the second detection signal so that a selected wavelength is obtained, and
following the selecting a further exciting and detecting, wherein the partial area of the sample is exposed to excitation light of the selected wavelength and wherein fluorescent light emitted from the partial area of the sample as a result of the excitation with the excitation light of the selected wavelength by the singulated fluorophore of the dye is detected and a further detection signal is obtained,
together with obtaining the further detection signal, a further localising of the singulated fluorophore and obtaining a further localisation.

7. The method according to claim 6, wherein the step of selecting of the wavelength is performed by evaluating the first detection signal and/or the second detection signal with respect to the dye whose singulated fluorophore has emitted the detected fluorescent light.

8. The method according to claim 6, wherein the selected wavelength is the first wavelength or the second wavelength.

9. The method according to claim 6, wherein the excitation light of the selected wavelength is focused light having a focal point and having an intensity distribution which has a central minimum and wherein the step of the further exciting and detecting is performed by positioning the focal point of the excitation light of the selected wavelength at a nominal sequence of locations within the partial area enclosing a central location calculated from the first localisation and/or the second localisation, the enclosed area having a second extent smaller than the first extent, within the partial area, wherein the central location
is the first localisation, if the selected wavelength is the first wavelength,
is the second localisation, if the selected wavelength is the second wavelength,
is determined by interpolation from the first and second localisations, if the selected wavelength is a further wavelength lying between the first and second wavelengths, and
is determined by extrapolation from the first localisation and the second localisation, if the selected wavelength is a further wavelength greater than the first and second wavelengths or less than the first and second wavelengths.

10. The Method according to claim 2, wherein the step of the first exciting and detecting is terminated after a predetermined time span or when a light quantity value of the first detection signal has reached a threshold value.

11. The method according to claim 6, wherein the selected wavelength is the first wavelength and wherein the further exciting and detecting and the further localising of the singulated fluorophore are carried out contiguously or iteratively until a further localisation with at most a predetermined uncertainty is obtained, the further localisation in this case being the first localisation, and wherein the step of the second exciting and detecting and the step of the second localising are carried out only after the termination of the step of the further exciting and detecting.

12. The method according to claim 2, wherein the steps of the method are carried out for a multitude of partial areas of the sample, the set of partial areas thus obtained including both partial areas from which fluorescent light was emitted and detected by a respective singulated fluorophore of a first dye, as well as those from which fluorescent light was emitted and detected by a respective singulated fluorophore of another dye.

13. The method according to claim 12, wherein a map with correction vectors for the co-registration of all localisations in a common spatial reference system is determined from the localisations and the differences of the localisations of the individual singulated fluorophores obtained with excitation light of different wavelengths.

14. The method according to claim 13, wherein for each of the localisations information is stored about the time at which the exciting and detecting for the localising took place, and that the map with correction vectors is a map dependent on a time coordinate.

15. The method according to claim 13, wherein an image of the sample is generated from the first localisations and the second localisations and/or the first and the further localisations and/or the second and the further localisations and optionally from other localisations obtained by means of excitation with excitation light of the first wavelength or the second wavelength or one of the further wavelengths and detection.

16. The method according to claim 1, wherein the partial area of the sample is a wide-field area and wherein the detecting is an imaging of the partial area onto a wide-field detector, wherein fluorescent light emitted from the singulated fluorophore is detected spatially resolved on the wide-field detector so that a spatially resolved detection signal is obtained, wherein, during the first exciting and detecting and the second exciting and detecting from the partial area of the sample fluorescent light emitted by multiple singulated fluorophores as a result of the excitation with excitation light of the respective wavelength is detected in total, and a first and a second spatially resolved detection signal is obtained for a plurality of singulated fluorophores, respectively.

17. The method according to claim 16, further comprising
a first and a second localising of a plurality of singulated fluorophores based on the respective first and second spatially resolved detection signals and obtaining respective first and second localisations; and
determining a difference between the respective first localisation and the respective second localisation.

18. The method according to claim 16, wherein the first exciting and detecting and the second exciting and detecting are performed simultaneously.

19. The method according to claim 16, further comprising
selecting of a wavelength from a predetermined set of at least two wavelengths for further exciting of the partial area of the sample based on at least the set of first and second detection signals so that a selected wavelength is obtained, and
following the selecting a further exciting and detecting, wherein the partial area of the sample is exposed to excitation light of the selected wavelength and wherein fluorescent light emitted from the partial area of the sample as a result of the excitation with the excitation light of the selected wavelength by a plurality of singulated fluorophores is detected and a further detection signal is obtained in each case,
a further localising of the multiple singulated fluorophores based on the further detection signal, respectively, and obtaining a further localisation, respectively,
wherein the selecting of the wavelength is performed by evaluating the set the first and second detection signals with respect to the species of dye whose singulated fluorophores have emitted the detected fluorescent light which has caused the predominant portion of the set of detection signals obtained.

20. The method according to claim 19, wherein the selected wavelength is the first wavelength or the second wavelength.

21. A localisation microscopic method for examining a sample stained with multiple dyes comprising
a testwise exciting and detecting, wherein a partial area of the sample is exposed to excitation light of a test wavelength and wherein fluorescent light emitted from the partial area of the sample as a result of the excitation with the excitation light of the test wavelength by a singulated fluorophore is detected and a test detection signal is obtained,
a selecting of a first wavelength from a predetermined set of at least two wavelengths and/or selecting of a small-field area within the partial area for subsequent excitation of the partial area of the sample based on at least the test detection signal,
a first exciting and detecting, wherein the partial area of the sample or the small-field area within the partial area of the sample is exposed to excitation light of the first wavelength and wherein fluorescent light emitted from the partial area of the sample or from the small-field area within the partial area of the sample as a result of the excitation with the excitation light of the first wavelength by the singulated fluorophore is detected and a first detection signal is obtained,
a first localising of the singulated fluorophore and obtaining a first localisation.

22. The method according to claim 21, further comprising
a selecting of a first wavelength from a predetermined set of at least two wavelengths for subsequent excitation of the sample portion based on at least the test detection signal,
prior to the selecting of the first wavelength from a predetermined set of at least two wavelengths, and after the testwise exciting and detecting, a second testwise exciting, wherein the partial area of the sample or the small-field area within the partial area is exposed to excitation light of a second test wavelength and wherein fluorescent light emitted from the partial area of the sample or from the small-field area within the partial area as a result of the excitation with the excitation light of the second test wavelength by a singulated fluorophore is detected and a second test detection signal is obtained, and in that the selecting of a first wavelength is performed on the basis of at least the first and the second test detection signals, wherein the first test detection signal and/or the second test detection signal is a light quantity value of the detected fluorescent light.

23. The method according to claim 21, wherein the selecting of the first wavelength is based on a comparison of the first and/or the second test detection signal with a predetermined reference value or with predetermined reference values or based on the ratio of the first test detection signal to the second test detection signal.

24. The method according to claim 21, further comprising
a selecting of a second wavelength from a predetermined set of at least two wavelengths for subsequent excitation of the partial area of the sample,
a second exciting and detecting, wherein the partial area of the sample is exposed to excitation light of the second wavelength and wherein fluorescent light emitted from the partial area of the sample or the small-field area within the partial area as a result of the excitation with the excitation light of the second wavelength by the singulated fluorophore is detected and a second detection signal is obtained,
a second localising of the singulated fluorophore and obtaining a second localisation, and
a determining a difference between the first localisation and the second localisation.

25. The method according to claim 24, wherein the partial area of the sample is a small-field area.

26. The method according to claim 24, wherein after testwise exciting and detecting a selecting of a small-field area within the partial area takes place.

27. The method according to claim 25, wherein the first localising and/or the second localising within the small-field area is performed according to a MINFLUX method.

28. The method according to claim 26, wherein the first localising and/or the second localising within the small-field area is performed according to a MINFLUX method.

29. The method according to claim 25, wherein the steps of the method are carried out on a set of small-field areas of the sample, wherein the set of small-field areas thus obtained includes both small-field areas from each of which fluorescent light has been emitted and detected by a singulated fluorophore of a first dye and those from each of which fluorescent light has been emitted and detected by a singulated fluorophore of another dye.

30. The method according to claim 29, wherein from the localisations and the differences of the localisations of the individual singulated fluorophores obtained with excitation light of different wavelengths, a map with correction vectors for the co-registration of all localisations in a common spatial reference system is determined.

31. The method according to claim 30, wherein for each of the localisations information is stored about the time at which the exciting and detecting for the localisation took place and that the map with correction vectors is a map dependent on a time coordinate.

32. The method according to claim 30, wherein from the first and the second and optionally from other localisations obtained by means of excitation with excitation light of the first wavelength or the second wavelength or optionally of a further wavelength, an image of the sample is generated in which fluorophores of different dye species are co-localized.

33. A microscope adapted to carry out a method according to claim 1 comprising:
a laser unit for the excitation of fluorescence, which is arranged to emit narrowband light of two wavelengths, or two laser units for the excitation of fluorescence, which together are arranged to emit narrowband light of two wavelengths,
a detection unit,
a selection unit arranged to select a wavelength for excitation based on a detection signal relating to fluorescence emission from a single fluorophore,
a calculation unit which is arranged to determine a localisation and a difference of the localisations from two detection signals with respect to a fluorescence emission of a single fluorophore, respectively.

34. A microscope adapted to carry out a method according to claim 21 comprising:
a laser unit for the excitation of fluorescence, which is arranged to emit narrowband light of two wavelengths, or two laser units for the excitation of fluorescence, which together are arranged to emit narrowband light of two wavelengths,
a detection unit,
a selection unit arranged to select a wavelength for excitation based on a detection signal relating to fluorescence emission from a single fluorophore,
a calculation unit which is arranged to determine a localisation and a difference of the localisations from two detection signals with respect to a fluorescence emission of a single fluorophore, respectively.
